(19) United States
(12) Patent Application Publication
(10) Pub. No.: US 2009/0058782 A1
(43) Pub. Date: Mar. 5, 2009

(54) METHOD OF DRIVING AN ACTIVE MATRIX LIQUID CRYSTAL DISPLAY

(75) Inventors: Hidetoshi WATANABE, Kobe (JP); Yasuyuki Onda, Kobe (JP); Hideto Maniwa, Kobe (JP)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/196,152

(22) Filed: Aug. 21, 2008

(30) Foreign Application Priority Data
Aug. 22, 2007 (JP) JP2007-216354

(51) Int. Cl. G09G 3/36

(52) U.S. Cl. 345/94

(57) ABSTRACT

A method for driving an active matrix liquid crystal display (AMLCD) to perform partial display area displaying on a portion of a display area thereof is disclosed. The method includes: using a common electrode voltage for line alternate-driving in a first write period of a partial display area, and for frame alternate-driving in at least a portion of a second write period outside of the partial display area; and in a frame alternate-driving period of the second write period outside of the partial display area, controlling the common electrode voltage to adjust one of two voltage durations of the common electrode voltage which are respectively before and after the first write period of the partial display area and in which the common electrode voltage are of the same polarity, to make the two voltage durations have equal lengths.

### CROSS REFERENCE TO RELATED APPLICATIONS

This Application claims priority of Japanese Patent Application No. 2007-216354, filed on Aug. 22, 2007, the entirety of which is incorporated by reference herein.

### BACKGROUND OF THE INVENTION

1. Field of the Invention

The invention relates to a method for driving an active matrix liquid crystal display (AMLCD).

2. Description of the Prior Art

In an active matrix liquid crystal display, a predetermined signal waveform voltage is applied to a common electrode opposed to a pixel electrode while scan electrodes are sequentially scanned from a top section to a middle section and bottom section of a display area. Additionally, a predetermined write signal waveform voltage can be applied to a source electrode for writing a signal to the pixel electrode such that a pixel voltage is generated between the pixel electrode and the common electrode for displaying images.

FIG. 14 is a timing chart showing signal (voltage) waveforms on electrodes in an AMLCD when, for normal display, the AMLCD displays images using all portions of its display area (i.e., full display area).

For brevity, say a display area of the AMLCD comprises 8 lines of pixels (electrodes). Dummy gates are respectively provided before the first line of the display area and after the last line of the display area. Dummy gates have overlap capacitances, between the pixel electrode and a previous or next scan line (gate line) which may influence displaying, but it is not a necessary requirement.

In a full display area example, a common electrode voltage is used for performing line alternate-driving. Data 1˜8 corresponding to pixel lines 1˜8 are output from source electrodes. Dummy scan data D equivalent to an OFF-color voltage D are output for dummy gates from source electrodes. Here, the OFF color means the color when the display is off. For example, the black color of a normally black AMLCD or the white color of a normally white AMLCD.

Each of the pixel electrodes and dummy gates is sequentially scanned in every frame time period. In the full display area example, all frame time periods are refresh frame time periods. In addition, a low level scan signal means that a holding operation is being performed.

The color mode for the display area, for example, is an 8-color mode or full-color mode. Off areas, in which images are not displayed, do not exist in the full display area example.

On the other hand, for an AMLCD, partial display area displaying may be performed to save power consumption, using a portion of the display area.

Pixel voltages are generated between the pixel electrodes on a partial display area and the common electrode, such that only a portion of the display area can display images. For example, the partial display area, displays images in the top portion, middle portion or bottom portion of the display area, or in the top portion and bottom portion of the display area wherein the remaining areas of the display area serve as the Off area.

Approaches for partial display area displaying in an AMLCD are disclosed, such as in Japan laid-open patent 2001-356746. One of the conventional driving methods for partial display area displaying is described as follows.

FIG. 15 is a timing chart showing signal (voltage) waveforms on electrodes of an AMLCD when performing partial display area displaying according to a conventional Example 1.

In the Example 1, 4 lines (the 3rd to 6th lines) of the 8-line display area (8 lines of pixel electrodes) are used to perform partial display area displaying.

In the Example 1, the common electrode voltage Vcom is used for line alternate-driving.

Data 3˜6 are output from a source electrode driving circuit for the 3rd˜6th lines for partial display area displaying. Voltage W for displaying an OFF color is output by the source electrode driving circuit for the 1st˜2nd and 7th˜8th lines, serving as Off areas of the 8-line display area. Dummy scan data D are output for dummy gates by the source electrode driving circuit.

Each of the pixel electrodes and dummy gates is sequentially scanned in every frame time period. In the Example 1, all frame time periods are refresh frame time periods, and refresh rates of the Off area and the partial display area are the same.

The color mode for the partial display area, for example, is an 8-color mode or full-color mode.

FIG. 16 is a timing chart showing signal (voltage) waveforms on electrodes of an AMLCD when performing partial display area displaying according to a conventional Example 2.

In the Example 2, 4 lines (the 3rd to 6th lines) of the 8-line display area (8 lines of pixel electrodes) are used to perform partial display area displaying.

In the Example 2, refresh rate for the Off area is ⅓ times that of the partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Although the common electrode voltage Vcom is used for line alternate-driving, it becomes a middle voltage during a non-refresh frame time period in which the Off area and dummy gates are not refreshed.

Data 3˜6 are output from a source electrode driving circuit for the 3rd˜6th lines of the partial display area. Voltage W for displaying an OFF color is output by the source electrode driving circuit for the 1st˜2nd and 7th˜8th lines of the Off areas and the source electrode driving circuit does not output the voltage W during the non-refresh frame time period. In addition, dummy scan data D equivalent to the OFF-color voltage are output for dummy gates by the source electrode driving circuit and the source electrode driving circuit does not output dummy scan data D during the non-refresh frame time period.

The color mode for the partial display area, for example, is an 8-color mode or full-color mode.

In the Example 2, by setting the non-refresh frame time period of the Off area to make the refresh rate for the Off area to be ⅓ times that of the partial display area, power consumption is reduced. However, compared with the conventional arts depicted in FIGS. 14 and 15, power saving is not considerable.

In addition to Examples 1 and 2, other methods for partial display area displaying are disclosed, but they also encounter display problems and do not meet expected goals.

The methods for driving conventional AMLCDs for partial display area displaying and problems resulting from the methods will be described as follows.

FIG. 17 is a timing chart showing signal (voltage) waveforms on electrodes of an AMLCD when performing partial display area displaying according to a conventional Example 3.

In the Example 3, 4 lines (the 3rd to 6th lines) of the 8-line display area (8 lines of pixel electrodes) are used to perform partial display area displaying.

In the Example 3, the common voltage Vcom is used for frame alternate-driving.

Data 3˜6 are output from a source electrode driving circuit for the 3rd˜6th lines for partial display area displaying. Voltage W for displaying an OFF color is output by the source electrode driving circuit for the 1st˜2nd and 7th˜8th lines which serve as the Off areas of the 8-line display area. Dummy scan data D having voltage equivalent to the OFF-color voltage are output for dummy gates by the source electrode driving circuit.

Each of the pixel electrodes and dummy gates is sequentially scanned in every frame time period. In the Example 3, all frame time periods are refresh frame time periods, and refresh rates for the Off area and the partial display area are the same.

The color mode for the partial display area, for example, is an 8-color mode or full-color mode.

The one difference between the Examples 3 and 1 is that the common electrode voltage Vcom is used for frame alternate-driving in the Example 3, and the common electrode voltage Vcom is used for line alternate-driving in the Example 1.

Compared with the Example 1, the driving method of the Example 3 considerably reduces power consumption by using the common electrode voltage Vcom for frame alternate-driving.

However, in the Example 3, the common electrode voltage Vcom is used for frame alternate-driving. Therefore, flickers easily occur on the partial display area due to lower refresh rate. Flickers are more obvious in a full-color mode.

FIG. 18 is a timing chart showing signal (voltage) waveforms on electrodes of an AMLCD when performing partial display area displaying according to a conventional Example 4.

In the Example 4, 4 lines (the 3rd to 6th lines) of the 8-line display area (8 lines of pixel electrodes) are used to perform partial display area displaying.

In the Example 4, refresh rate for the Off area is ⅓ times that of the partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Data 3˜6 are output from a source electrode driving circuit for the 3rd˜6th lines of the partial display area. Voltage W for displaying an OFF color is output by the source electrode driving circuit for the 1st˜2nd and 7th˜8th lines of the Off area in a refresh frame time period of the Off area. However, gate scanning is not performed in a non-refresh frame time period of the Off area, and thus outputs of the source electrode driving circuit basically have no association with image displaying and can be any output. Meanwhile, dummy scan data D equivalent to the OFF-color voltage are output for dummy gates by the source electrode driving circuit during the refresh frame time period of the Off area. However, gate scanning is not performed during the non-refresh frame time period of the Off area, and thus outputs of the source electrode driving circuit basically have no association with image displaying and can be any output.

The color mode for the partial display area, for example, is an 8-color mode or full-color mode.

The one difference between the Examples 4 and 2 is that the common electrode voltage Vcom is used for frame alternate-driving in the Example 4, and the common electrode voltage Vcom is used for line alternate-driving in the Example 2.

Compared with the Example 2, the driving method of the Example 4 considerably reduces power consumption by using the common electrode voltage Vcom for frame alternate-driving.

In the Example 4, however, the common electrode voltage Vcom is used for frame alternate-driving, therefore, flickers easily occur on the partial display area due to lower refresh rate. Flickers are more obvious in a full-color mode.

FIG. 19 is a timing chart showing signal (voltage) waveforms on electrodes of an AMLCD when performing partial display area displaying according to a conventional Example 5.

In the Example 5, 4 lines (the 3rd to 6th lines) of the 8-line display area (8 lines of pixel electrodes) are used to perform partial display area displaying.

In the Example 5, the common voltage Vcom is used for line alternate-driving in a first scan period for the partial display area, and for frame alternate-driving in a second scan period for the Off area and the dummy gates.

Data 3˜6 are output from a source electrode driving circuit for the 3rd˜6th lines for partial display area displaying. Voltage W for displaying an OFF color is output by the source electrode driving circuit for the 1st˜2nd and 7th˜8th lines which serve as the Off areas of the 8-line display area. Dummy scan data D having voltage equivalent to the OFF-color voltage are output for dummy gates by the source electrode driving circuit.

Each of the pixel electrodes and dummy gates is sequentially scanned in every frame time period. In the Example 5, all frame time periods are refresh frame time periods, and refresh rates for the Off area and the partial display area are the same.

The color mode for the partial display area, for example, is an 8-color mode or full-color mode.

In FIG. 19 of the Example 5, the common electrode voltage Vcom is used for line alternate-driving in a first scan period for the partial display area, and for frame alternate-driving in a second scan period for the Off area and dummy gates. In FIG. 15 of the Example 1, the common electrode voltage Vcom is used for line alternate-driving. In FIG. 17 of the Example 3, the common electrode voltage Vcom is used for frame alternate-driving in a second scan period for the Off area and dummy gates. The driving method of the Example 5 can be seen as the combination of the driving methods of the Examples 1 and 3.

Compared with the Example 1, the Example 5 considerably reduces power consumption by using the common electrode voltage Vcom as described above.

In the Example 5, since the common electrode voltage is not used for frame alternate-driving all the time, flickers occurring in the Example 3 can be avoided by combining the line alternate-driving and frame alternate-driving. However, when lengths (or durations) of the frame alternate-driving for the Off area and dummy gates, before and after a writing period for the partial display area, are different, stripe defects will occur every other line. Specifically, for n-line alternate-driving, stripe defects will occur every other n lines where n≧1. Stripe defects are more obvious in a full-color mode.

FIG. 20 is a timing chart showing signal (voltage) waveforms on electrodes of an AMLCD when performing partial display area displaying according to a conventional Example 6.

In the Example 6, 4 lines (the 1st to 4th lines) of the 8-line display area (8 lines of pixel electrodes) are used to perform partial display area displaying.

In the Example 6, refresh rate for the Off area is ⅓ times that of the partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

In the Example 6, the common electrode voltage Vcom is used for line alternate-driving in a first scan period for the partial display area, and for frame alternate-driving in a second scan period for the Off area and the dummy gates. The common electrode voltage becomes a middle voltage during a non-refresh frame time period in which the Off area and dummy gates are not refreshed.

Data 1˜4 are output from a source electrode driving circuit for the 1st˜4th lines of the partial display area. Voltage W for displaying an OFF color is output by the source electrode driving circuit for the 5th˜8th lines of the Off area and the source electrode driving circuit can output any data during the non-refresh frame time period. In addition, dummy scan data D equivalent to the OFF-color voltage are output for dummy gates by the source electrode driving circuit and the source electrode driving circuit can output any data during the non-refresh frame time period of the Off area and dummy gates.

The color mode for the partial display area, for example, is an 8-color mode or full-color mode.

In FIG. 20 of the Example 6, the common electrode voltage Vcom is used for line alternate-driving in the first scan period for the partial display area, and for frame alternate-driving in the second scan period for the Off area and the dummy gates. Also, the common electrode voltage Vcom becomes the middle voltage during the non-refresh frame time period. Therefore, the driving method of the Example 6 can be seen as the combination of the Examples 2 and 3.

The Example 6 adopts the driving method described above and makes the common electrode voltage Vcom become the middle voltage during the non-refresh frame time period of the Off area and the dummy gates. Thus, compared with the Example 5, the Example 6 can reduce power consumption.

Meanwhile, the common electrode voltage Vcom is not used all the time for frame alternate-driving in the Example 6. Therefore, flickers occurring in the Example 3 can be avoided by combining the line alternate-driving and frame alternate-driving.

However when the common electrode voltage is used for frame alternate-driving in a write period of the Off area and the dummy gates, before and after a write period of the partial display area, positive or negative voltage (high level or low level voltage) durations (or lengths) A and B of the common electrode voltage are different (A≠B). Consequently, stripe defect occur every other line. Specifically, for n-line alternate-driving, stripe defects occur every other n lines where n≧1. Stripe defects are more obvious in a full-color mode.

FIG. 21 is a timing chart showing signal (voltage) waveforms on electrodes of an AMLCD when performing partial display area displaying according to a conventional Example 7.

In the Example 7, 4 lines (the 3rd to 6th lines) of the 8-line display area (8 lines of pixel electrodes) are used to perform partial display area displaying.

In the Example 6, refresh rate for the Off area is ⅓ times that of the partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

In the Example 7, the common electrode voltage Vcom is used for line alternate-driving in a first scan period for the partial display area, and for frame alternate-driving in a second scan period for the Off area and the dummy gates. The common electrode voltage becomes a middle voltage during a non-refresh frame time period in which the Off area and dummy gates are not refreshed.

Data 3˜6 are output from a source electrode driving circuit for the 3rd˜6th lines of the partial display area. Voltage W for displaying an OFF color is output by the source electrode driving circuit for the 1st˜2nd and 7th˜8th lines of the Off areas and the source electrode driving circuit can output any data during the non-refresh frame time period. In addition, dummy scan data D equivalent to the OFF-color voltage are output for dummy gates by the source electrode driving circuit and the source electrode driving circuit can output any data during the non-refresh frame time period of the Off area and dummy gates.

The color mode for the partial display area, for example, is an 8-color mode or full-color mode.

In FIG. 21 of the Example 7, the common electrode voltage Vcom is used for line alternate-driving in the first scan period for the partial display area, and for frame alternate-driving in the second scan period for the Off area and the dummy gates. Also, the common electrode voltage Vcom becomes the middle voltage during the non-refresh frame time period. Therefore, the driving method of the Example 7 is the same as that described in the Example 6.

The Example 7 adopts the driving method described above and makes the common electrode voltage Vcom become the middle voltage during the non-refresh frame time period of the Off area and the dummy gates. Thus, compared with the Example 5, the Example 7 can reduce power consumption.

Meanwhile, the common electrode voltage Vcom is not used all the time for frame alternate-driving in the Example 7. Therefore, flickers occurring in the Example 3 can be avoided by combining the line alternate-driving and frame alternate-driving.

There is a difference between Example 7 and Example 6. In Example 7 when the common electrode voltage is used for frame alternate-driving in a write period of the Off area and the dummy gates, before and after a write period of the partial display area, positive or negative voltage (high level or low level voltage) durations (or lengths) A and B of the common electrode voltage are the same (A=B). Consequently, stripe defects does not occur every other line. Specifically, for n-line alternate-driving, stripe defects does not occur every other n lines where n≧1.

Therefore, for specific circumstances, displaying a partial display area in the center of a full display area can remove flickers and stripe defects by using the driving method of the Example 7, thereby solving the displaying problems of the conventional AMLCD.

### BRIEF SUMMARY OF INVENTION

The invention is directed to a method for driving an active matrix liquid crystal display (AMLCD). Based on the invention, flickers and stripe defects in the AMLCD can be prevented and power saving of the AMLCD can be achieved, when any portion of the full display area is set as the partial display area of the AMLCD.

According to an exemplary disclosure of the invention, a method for driving an AMLCD to perform partial display area displaying on a portion of a display area thereof, comprises: using a common electrode voltage for line alternate-driving in a first write period of a partial display area, and for frame alternate-driving in at least a portion of a second write period outside of the partial display area; and in a frame alternate-driving period of the second write period outside of the partial display area, controlling the common electrode voltage to adjust one of two voltage durations of the common electrode voltage which are respectively before and after the first write period of the partial display area and in which the common electrode voltage are of the same polarity, to make the two voltage durations have equal lengths.

According to the exemplary disclosure of the invention, in the frame alternate-driving period of the second write period outside of the partial display area, the common electrode voltage may be controlled such that a portion of one of the two voltage durations of the common electrode voltage is replaced by a middle voltage period, in which the common electrode voltage is set to a middle voltage of positive and negative common electrode voltages, thereby shortening one of the two voltage durations and making the two voltage durations of the same polarity have equal lengths.

According to the exemplary disclosure of the invention, in the frame alternate-driving period of the second write period outside of the partial display area, the common electrode voltage may be controlled such that one of the two voltage durations of the common electrode voltage is extended, thereby making the two voltage durations of the same polarity have equal lengths

According to the exemplary disclosure of the invention when the middle voltage period replacing one of the two voltage durations includes a write period of an Off area, a source electrode middle voltage is output by a source electrode driving circuit, in a refresh frame time period to pixel electrodes corresponding to the middle voltage period of the Off area where the source electrode middle voltage is a middle source voltage of a positive write and negative voltages from the source electrode driving circuit.

According to the exemplary disclosure of the invention when the middle voltage period replacing one of the two voltage durations includes a write period of dummy gates, and the source electrode middle voltage is output by the source electrode driving circuit, during the refresh frame time period for the dummy gates corresponding to the middle voltage period of the Off area.

According to another exemplary disclosure of the invention, a method for driving an AMLCD to perform partial display area displaying on a portion of a display area thereof, comprises: using a common electrode voltage for line alternate-driving in a first write period of a partial display area, and making the common electrode voltage become a middle voltage of a positive common voltage and a negative positive voltage in a second write period outside of the partial display area; and controlling the common electrode voltage to make two voltage durations of the common electrode voltage which are respectively before and after the first write period of the partial display area, have zero lengths of the same voltage polarity durations.

According to another exemplary disclosure of the invention when a middle voltage period, in which the common electrode voltage becomes the middle voltage, includes a write period of an Off area, a source electrode middle voltage is output by a source electrode driving circuit, in a refresh frame time period to pixel electrodes corresponding to the middle voltage period of the Off area where the source electrode middle voltage is a middle source voltage of a positive write and negative voltages from the source electrode driving circuit.

According to another exemplary disclosure of the invention when the middle voltage period in which the common electrode voltage becomes the middle voltage and a write period of dummy gates is included, the source electrode middle voltage is output by the source electrode driving circuit during the refresh frame time period for the dummy gates corresponding to the middle voltage period.

According to another exemplary disclosure of the invention, the line number of pixel electrodes for constructing the partial display area is set as an odd number.

According to another exemplary disclosure of the invention, an OFF-color voltage is output from a source electrode driving circuit to an additional pixel electrode which is used for setting the line number of pixel electrodes as the odd number.

According to another exemplary disclosure of the invention, only the pixel electrodes, except the additional pixel electrode, of the partial display area, is scanned in a non-refresh frame time period of the Off area.

According to another exemplary disclosure of the invention, a middle source voltage between a positive write voltage and a negative voltage is applied to source electrodes in a non-refresh frame time period of an Off area outside of the partial display area.

According to another exemplary disclosure of the invention, an output of a source electrode driving circuit is set as high impedance in a non-refresh frame time period of an Off area outside of the partial display area.

According to another exemplary disclosure of the invention, a middle source voltage between a positive write voltage and a negative voltage is first applied to source electrodes and then an output of a source electrode driving circuit is set as a high impedance in a non-refresh frame time period of an Off area outside of the partial display area.

According to the above described methods for driving the AMLCD, flicker and stripe defects in the AMLCD can be prevented and power saving of the AMLCD can be achieved when any portion of the full display area is set as the partial display area of the AMLCD.

### BRIEF DESCRIPTION OF DRAWINGS

The invention can be more fully understood by reading the subsequent detailed description and examples with references made to the accompanying drawings wherein:

FIG. 1 is a timing chart showing signal (voltage) waveforms on electrodes of an AMLCD when performing partial display area displaying according to an Embodiment 1 of the invention.

FIG. 2 is a timing chart showing signal (voltage) waveforms on electrodes of an AMLCD when performing partial display area displaying according to an Embodiment 2 of the invention.

FIG. 3 is a timing chart showing signal (voltage) waveforms on electrodes of an AMLCD when performing partial display area displaying according to an Embodiment 3 of the invention.

FIG. 4 is a timing chart showing signal (voltage) waveforms on electrodes of an AMLCD when performing partial display area displaying according to an Embodiment 4 of the invention.

FIG. 5 is a timing chart showing signal (voltage) waveforms on electrodes of an AMLCD when performing partial display area displaying according to an Embodiment 5 of the invention.

FIG. 6 is a timing chart showing signal (voltage) waveforms on electrodes of an AMLCD when performing partial display area displaying according to an Embodiment 6 of the invention.

FIG. 7 is a timing chart showing signal (voltage) waveforms on electrodes of an AMLCD when performing partial display area displaying according to an Embodiment 7 of the invention.

FIG. 8 is a timing chart showing signal (voltage) waveforms on electrodes of an AMLCD when performing partial display area displaying according to an Embodiment 8 of the invention.

FIG. 9 is a timing chart showing signal (voltage) waveforms on electrodes of an AMLCD when performing partial display area displaying according to an Embodiment 9 of the invention.

FIG. 10 is a timing chart showing signal (voltage) waveforms on electrodes of an AMLCD when performing partial display area displaying according to an Embodiment 10 of the invention.

FIG. 11 is a timing chart showing signal (voltage) waveforms on electrodes of an AMLCD when performing partial display area displaying according to an Embodiment 11 of the invention.

FIG. 12 is a timing chart showing signal (voltage) waveforms on electrodes of an AMLCD when performing partial display area displaying according to an Embodiment 12 of the invention.

FIG. 13 is a timing chart showing signal (voltage) waveforms on electrodes of an AMLCD when performing partial display area displaying according to an Embodiment 13 of the invention.

FIG. 14 is a timing chart showing signal waveforms on electrodes in an AMLCD when performing full display area displaying.

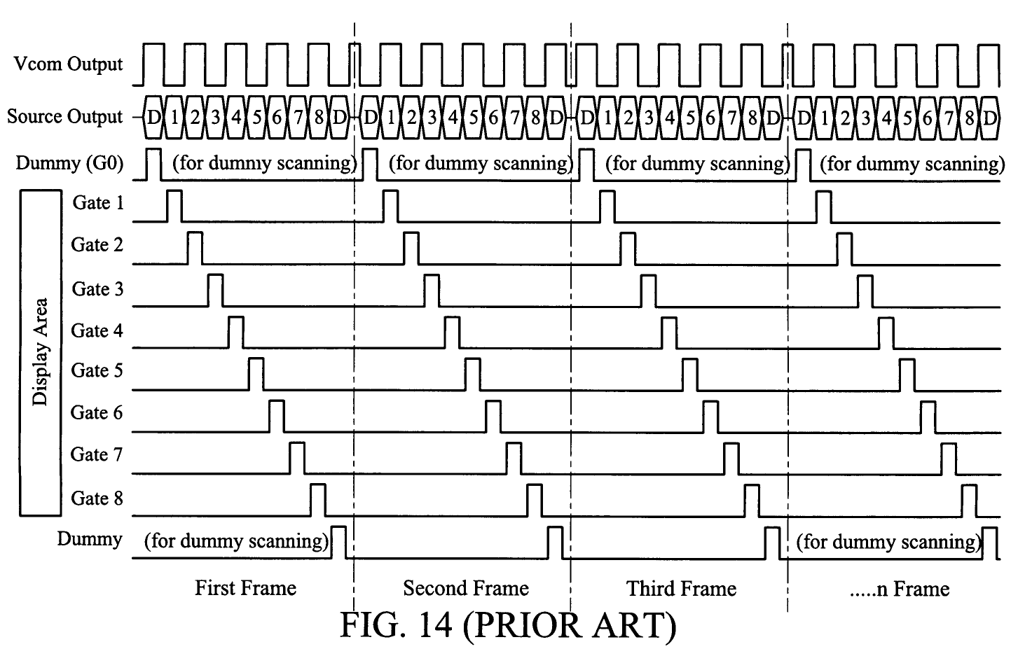

FIG. 15 is a timing chart showing signal (voltage) waveforms on electrodes of an AMLCD when performing partial display area displaying according to a conventional Example 1.

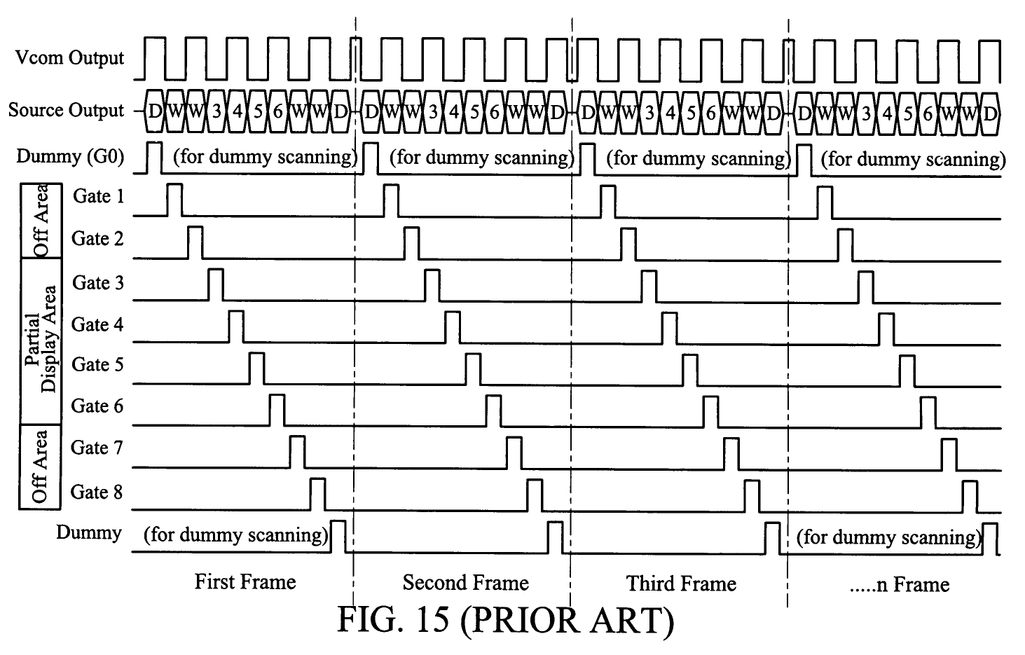

FIG. 16 is a timing chart showing signal (voltage) waveforms on electrodes of an AMLCD when performing partial display area displaying according to a conventional Example 2.

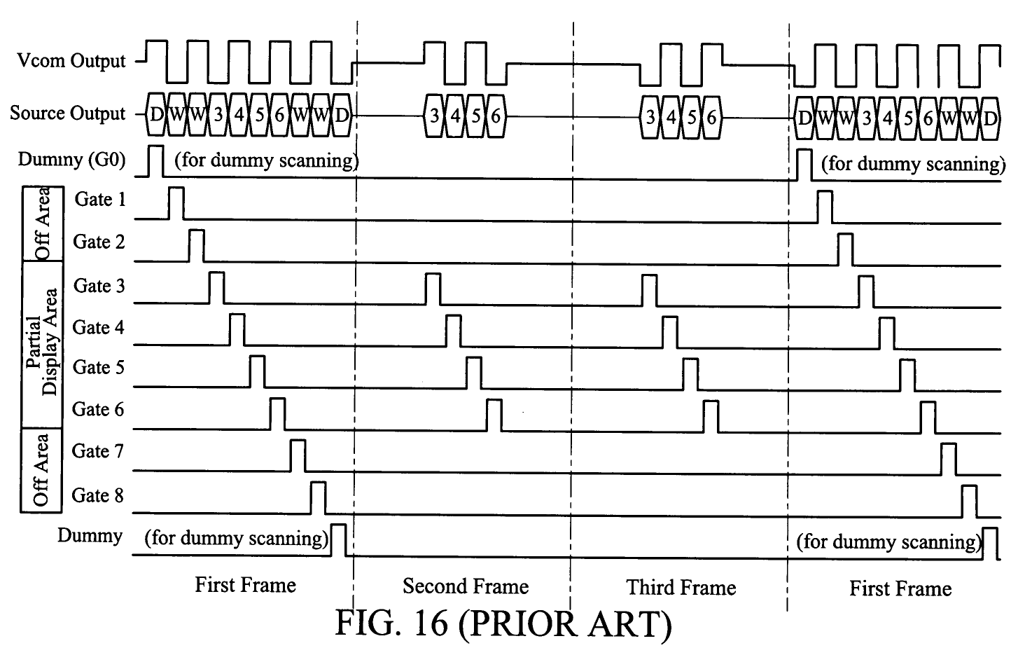

FIG. 17 is a timing chart showing signal (voltage) waveforms on electrodes of an AMLCD when performing partial display area displaying according to a conventional Example 3.

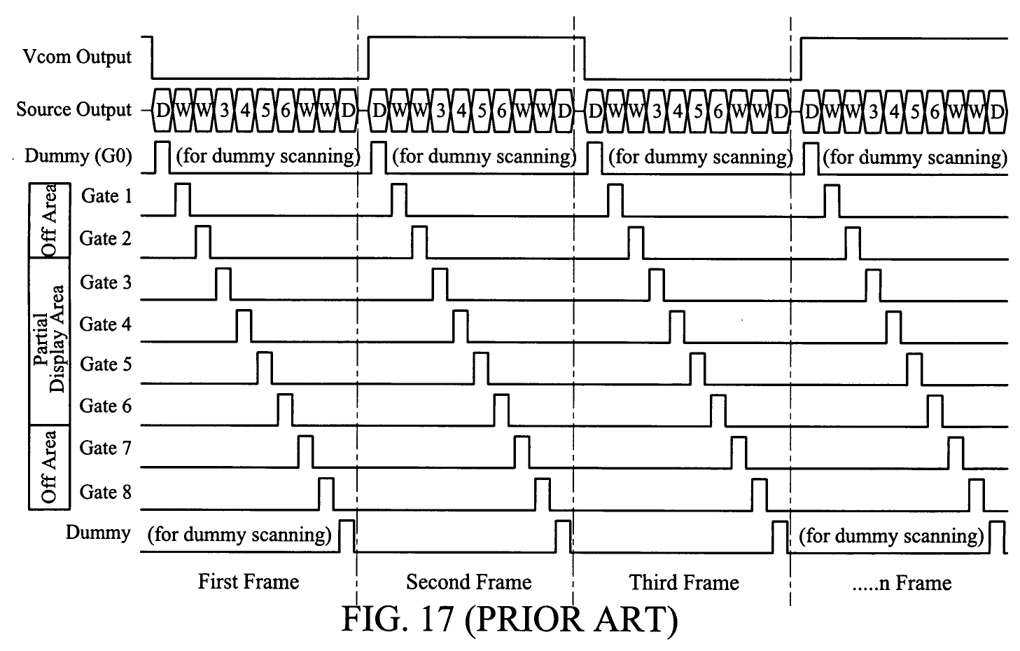

FIG. 18 is a timing chart showing signal (voltage) waveforms on electrodes of an AMLCD when performing partial display area displaying according to a conventional Example 4.

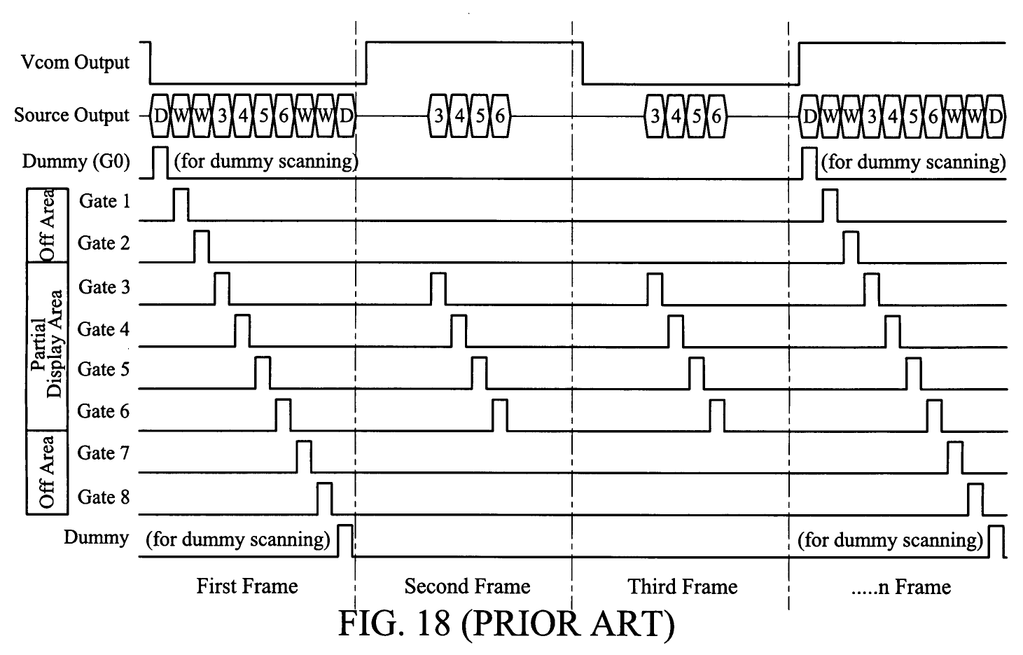

FIG. 19 is a timing chart showing signal (voltage) waveforms on electrodes of an AMLCD when performing partial display area displaying according to a conventional Example 5.

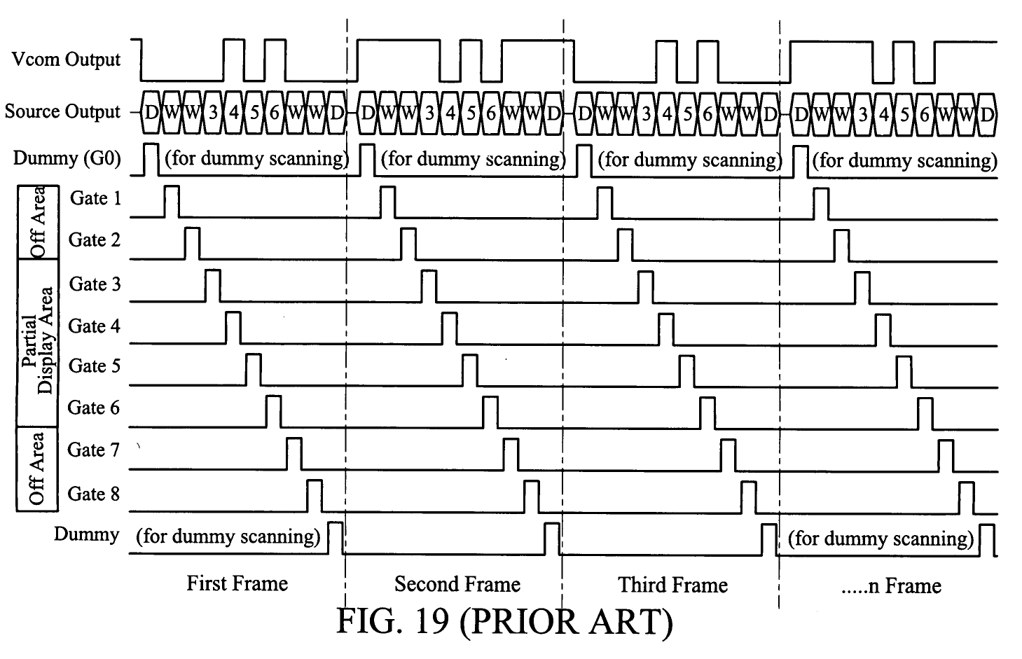

FIG. 20 is a timing chart showing signal (voltage) waveforms on electrodes of an AMLCD when performing partial display area displaying according to a conventional Example 6.

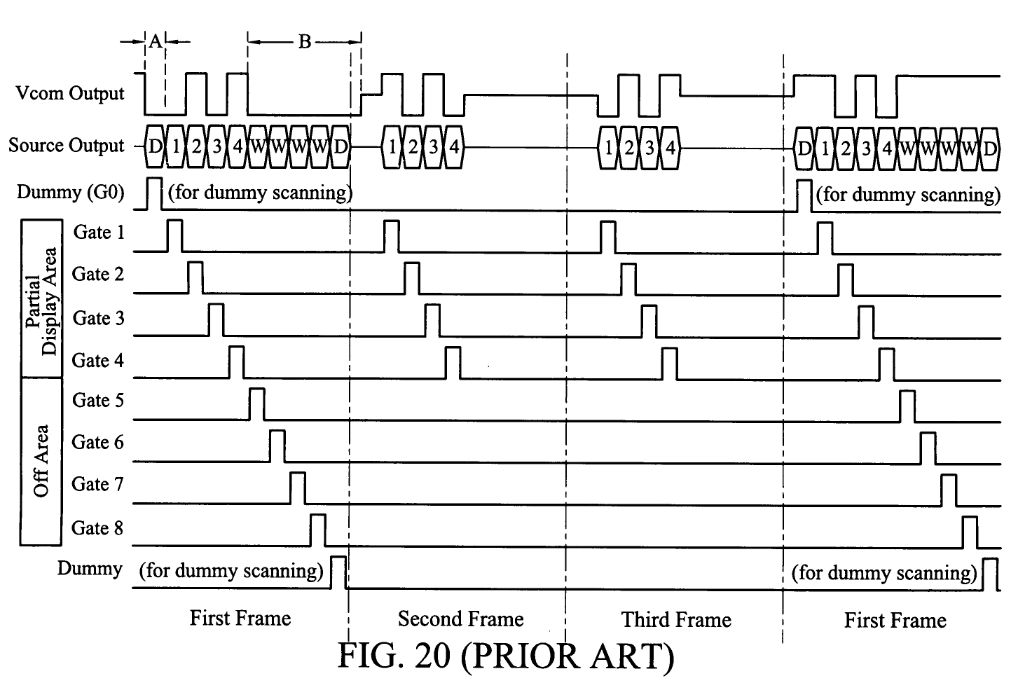

FIG. 21 is a timing chart showing signal (voltage) waveforms on electrodes of an AMLCD when performing partial display area displaying according to a conventional Example 7.

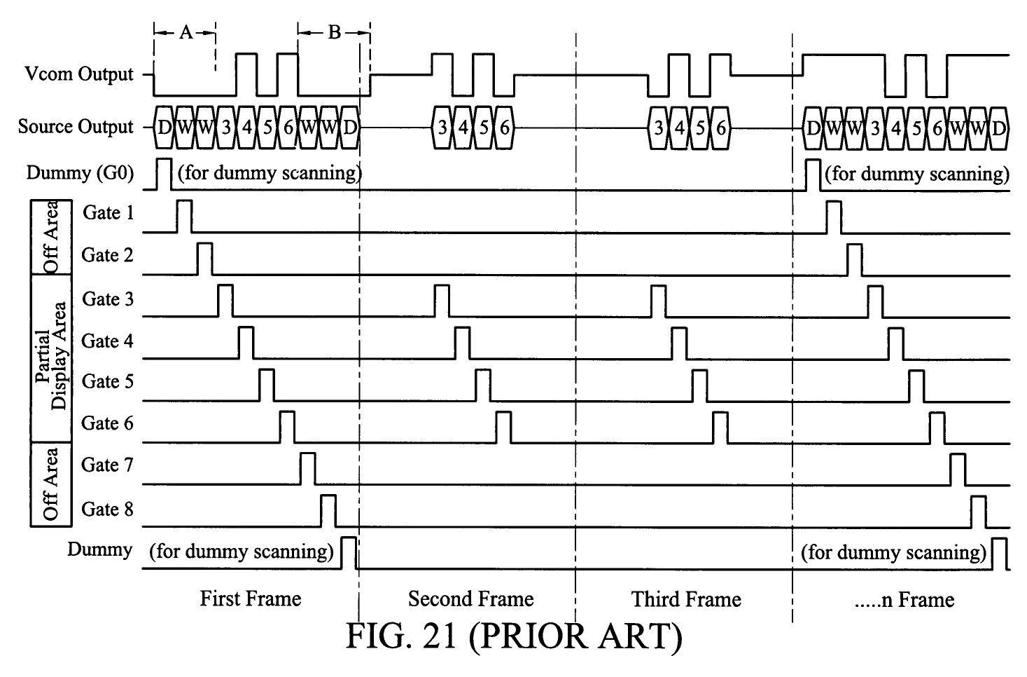

FIG. 22 shows a schematic circuit diagram of an active matrix liquid crystal display (AMLCD). The AMLCD can operate according to the AMLCD driving methods described in the embodiments of the invention.

FIG. 23 shows a perspective view of a mobile phone installed with an active matrix liquid crystal display driven by the AMLCD driving methods described in the embodiments of the invention.

### DETAILED DESCRIPTION OF INVENTION

Several exemplary embodiments of the present invention will now be described with reference to the accompanying drawings.

Driving methods for an active matrix display (AMLCD) according to embodiments of the invention are described hereinafter. For brevity, the full display area of the AMLCD described in the embodiments comprises 8 lines of pixels (or pixel electrodes). Dummy gates are respectively provided before the initial (1st) line of the display area and after the last (8th) line of the display area.

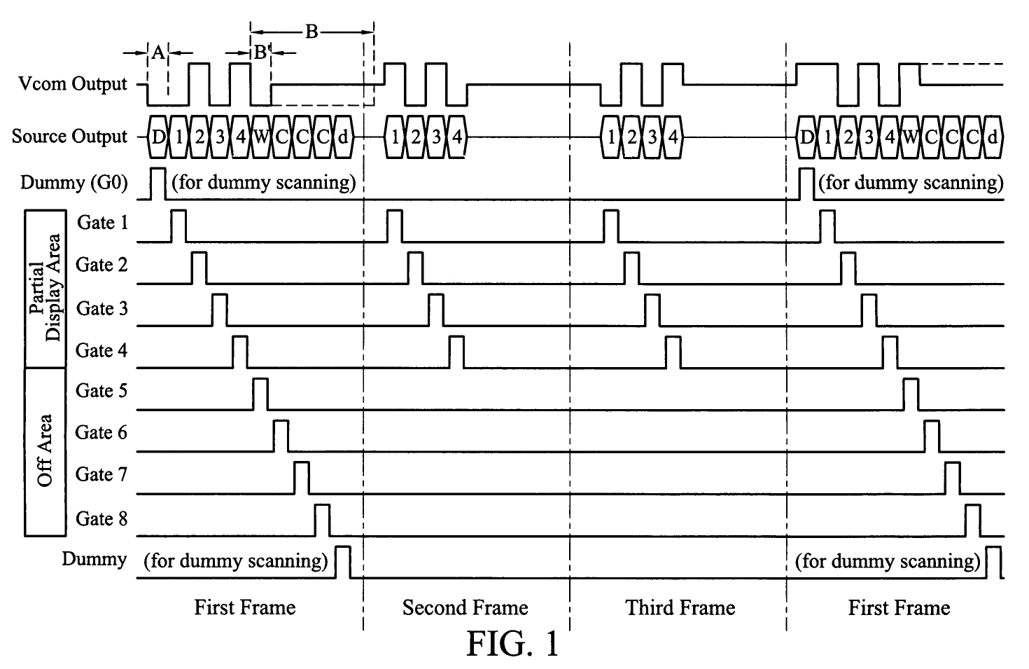

FIG. 1 is a timing chart showing signal (voltage) waveforms on electrodes of an AMLCD when performing partial display area displaying according to an Embodiment 1 of the invention.

In the Embodiment 1, 4 lines (the 1st to 4th lines) of the 8-line display area (8 lines of pixel electrodes) are used to perform partial display area displaying.

In the Embodiment 1, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Data 1˜4 are output from a source electrode driving circuit for the 1st˜4th lines of the partial display area. Voltage W for displaying an OFF color is output from the source electrode driving circuit for the 5th line of the Off area (including 5th˜8th lines) in a refresh frame time period (in which the Off area is scanned or refreshed) and the source electrode driving circuit can output any data in a non-refresh frame time period (in which the Off area is not scanned or refreshed). In addition, the source electrode driving circuit outputs a source electrode middle voltage C (i.e., a middle voltage of the source electrode) for the 6th˜8th lines of the Off area and does not output the voltage W for displaying an OFF color during the refresh frame time period wherein any data can be output during the non-refresh frame time period. The 6th˜8th lines of the Off area correspond to a middle voltage period in which the level of a common electrode voltage is equal to a middle voltage of a positive common voltage and a negative common voltage.

Dummy scan data D equivalent to an OFF-color voltage is output by the source electrode driving circuit for the dummy gate (G0) provided before the initial (the 1st) line of the display area during the refresh frame time period. In addition, dummy scan data d equivalent to the source electrode middle voltage is output by the source electrode driving circuit for the (9th-line) dummy gate provided after the last (the 8th) line of the display area of the dummy gates during the refresh frame time period. The source electrode driving circuit can output any data for the dummy gates during the non-refresh frame time period.

The reason why the dummy scan data d equivalent to the source electrode middle voltage is output for the 9th-line dummy gate during the refresh frame time period is described as follows. When the common electrode voltage Vcom is used for frame alternate-driving in a second write period of the Off area and the dummy gates, i.e., in a-frame alternate-driving period of the common electrode voltage, two voltage durations (A, B) of the common electrode voltage respectively before and after a first write period of the partial display area are of the same (positive or negative) polarity, and a portion of one of the two voltage durations (A, B) with the same polarity is replaced by the middle voltage period of the common electrode voltage. Thus, power saving can be achieved by outputting the dummy scan data d (i.e., the source electrode middle voltage) for the 9th-line dummy gate because the voltage duration (or length) of the same polarity is adjusted.

The color mode for the partial display area, for example, is an 8-color mode or full-color mode.

In the Embodiment 1, the common electrode voltage Vcom is used for line alternate-driving in a first scan period of the partial display area (i.e., in the first write period of the partial display area), and is used for frame alternate-driving in a second scan (or the second write) period of the Off area and the dummy gates (or in a second scan (or write) period outside of the partial display area). The common electrode voltage Vcom becomes the middle voltage during the non-refresh frame time period of the Off area and the dummy gates. In the frame alternate-driving period (the second write period outside of the partial display area), any of the two voltage durations (A, B) of the common electrode voltage Vcom respectively before and after the write period of the partial display area is adjusted to make the two voltage durations after adjusting become equal (A=B′), by tuning the duration (or length) of the high level or low level voltage period of the common electrode voltage Vcom.

Specifically, during the frame alternate-driving period (the second write period outside of the partial display area), any of the two voltage durations (A, B) of the common electrode voltage Vcom which are of the same polarity and respectively before and after the write period of the partial display area, is replaced by the middle voltage period. Here, a portion of the voltage duration B is replaced by the middle voltage period and the voltage duration B is shrunk to a voltage duration B′, thereby achieving equal voltage durations A and B′ (A=B′).

Because, during the frame alternate-driving period of the common electrode voltage, a portion of one of the two voltage durations of the common electrode voltage Vcom which is of the same polarity and respectively before and after the write period of the partial display area, is replaced by the middle voltage period, the dummy scan data d (i.e., the source electrode middle voltage), not the voltage equivalent to the OFF-color voltage, is applied to the 9th-line dummy gate corresponding to the middle voltage period during the refresh frame time period.

The method for driving the AMLCD according to the Embodiment 1 thus preventing stripe defects to occur in every other line (for n-line alternate-driving, stripe defects occur in every other n lines where n≧1 and is an integer).

Note that the best way to eliminate the stripe defects is to respectively adjust a portion of one of the two voltage durations (A, B) of the common electrode voltage Vcom during the frame alternate-driving period (the second write period outside of the partial display area) before and after the write period of the partial display area to make equal voltage durations (A=B′). Additionally, even if the two voltage durations A and B′ are not exactly equal, the stripe defects can still be prevented. Therefore, the term “equal” in the Embodiment 1 does not merely mean to be exactly equal but also means to be approximately equal to achieve prevention of stripe defects. The definition of “equal” is also applied to the following embodiments of the invention.

In addition, the common electrode voltage is applied to combine the line alternate-driving and the frame alternate-driving, thus preventing flickers.

Furthermore, the common electrode voltage becomes the middle voltage during the non-refresh frame time period of the Off area and the dummy gates, according to the driving method as described in the Embodiment 1. Therefore, output variations (or transients) of pixel electrode scanning or data from the source electrode driving circuit can be kept at a minimum, thereby achieving reduction of power consumption.

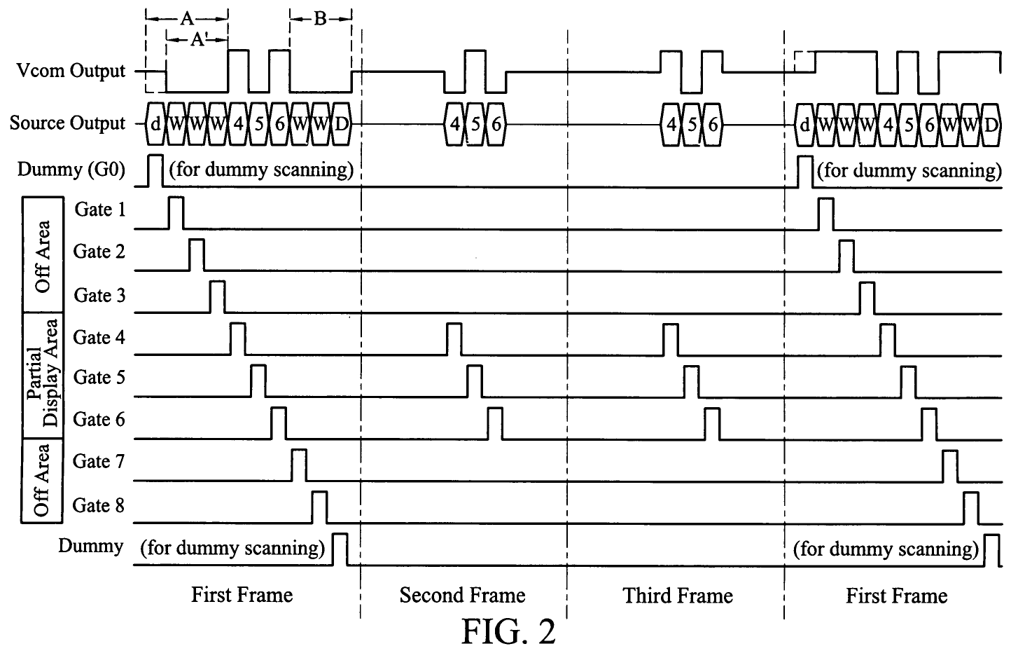

FIG. 2 is a timing chart showing signal (voltage) waveforms on electrodes of an AMLCD when performing partial display area displaying according to an Embodiment 2 of the invention.

In the Embodiment 2, 3 lines (the 4th to 6th lines) of the 8-line display area (8 lines of pixel electrodes) are used to perform partial display area displaying.

In the Embodiment 2, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Data 4˜6 are output from a source electrode driving circuit for the 4th˜6th lines of the partial display area. Voltage W for displaying an OFF color is output from the source electrode driving circuit for the 1st˜3rd and 7th˜8th lines of the Off area, in a refresh frame time period (in which the Off area is scanned or refreshed) and the source electrode driving circuit can output any data in a non-refresh frame time period (in which the Off area is not scanned or refreshed).

Dummy scan data d equivalent to the source electrode middle voltage, not the voltage equivalent to the OFF-color voltage, is output by the source electrode driving circuit for the dummy gate (G0) provided before the initial (the 1st) line of the display area during the refresh frame time period. The reason to output the dummy scan data d (i.e., the source electrode middle voltage) for the (0th-line) dummy gate (G0) is the same as that described in the Embodiment 1. In addition, Dummy scan data D equivalent to the OFF-color voltage is output by the source electrode driving circuit for the (9th-line) dummy gate provided after the last (the 8th) line of the display area during the refresh frame time period. The source electrode driving circuit can output any data for the dummy gates during the non-refresh frame time period.

The color mode for the partial display area, for example, is an 8-color mode or full-color mode.

In the Embodiment 2, the common electrode voltage Vcom is used for line alternate-driving in a first scan period of the partial display area (i.e., in a first write period of the partial display area), and is used for frame alternate-driving in a second scan (or write) period of the Off area and the dummy gates (or in a second scan (or write) period outside of the partial display area). The common electrode voltage Vcom becomes the middle voltage during the non-refresh frame time period of the Off area and the dummy gates. In the frame alternate-driving period (the second write period outside of the partial display area), any of the two voltage durations (A, B) of the common electrode voltage Vcom respectively before and after the write period of the partial display area is adjusted to make the two voltage durations after adjusting become equal (A′=B), by tuning the duration (or length) of the high level or low level voltage period of the common electrode voltage Vcom.

Specifically, in the frame alternate-driving period (the second write period outside of the partial display area), a longer one of the two voltage durations (A, B) of the common electrode voltage Vcom which are of the same polarity and respectively before and after the write period of the partial display area, is replaced by the middle voltage period. Here, a portion of the voltage duration A is replaced by the middle voltage period and the voltage duration A is shrunk to a voltage duration A′, thereby achieving equal voltage durations A′ and B (A′=B).

Because, in the frame alternate-driving period of the common electrode voltage, a portion of one of the two voltage durations of the common electrode voltage Vcom which are of the same polarity and respectively before and after the write period of the partial display area, is replaced by the middle voltage period, the dummy scan data d (i.e., the source electrode middle voltage), not the voltage equivalent to the OFF-color voltage, is applied to the 0th-line dummy gate (G0) corresponding to the middle voltage period during the refresh frame time period.

The method for driving the AMLCD according to the Embodiment 2 thus prevents stripe defects to occur in every other line (for n-line alternate-driving, stripe defects occur in every other n lines where n≧1 and is an integer).

In addition, the common electrode voltage is applied to combine the line alternate-driving and the frame alternate-driving, thus preventing flickers.

Furthermore, the common electrode voltage becomes the middle voltage during the non-refresh frame time period of the Off area and the dummy gates, according to the driving method as described in the Embodiment 2. Therefore, output variations (or transients) of pixel electrode scanning or data from the source electrode driving circuit can be kept at a minimum, thereby achieving reduction of power consumption.

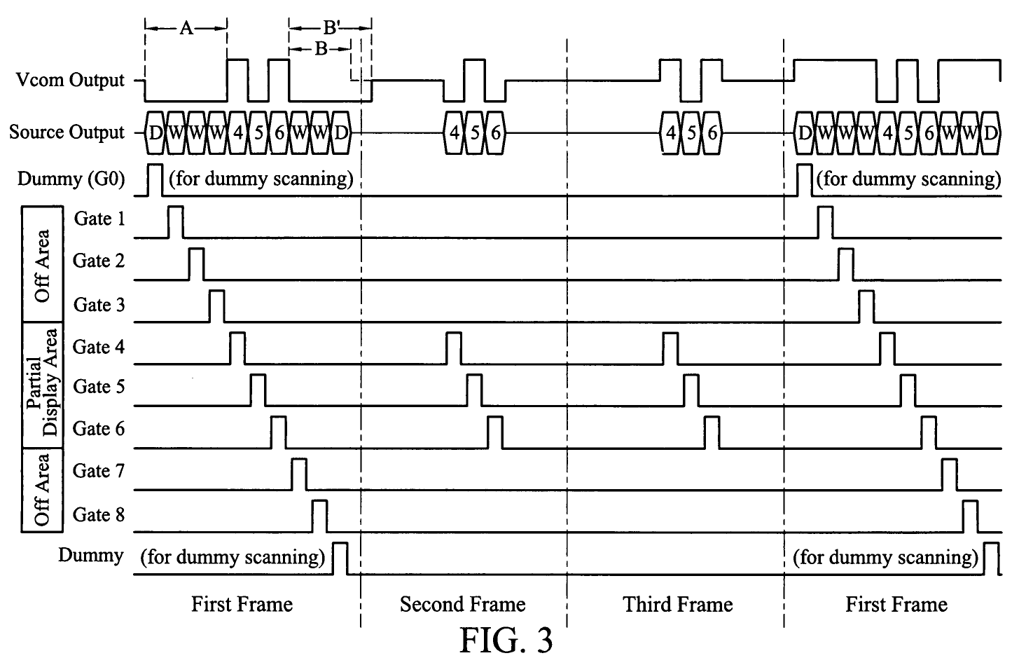

FIG. 3 is a timing chart showing signal (voltage) waveforms on electrodes of an AMLCD when performing partial display area displaying according to an Embodiment 3 of the invention.

In the Embodiment 3, 3 lines (the 4th to 6th lines) of the 8-line display area (8 lines of pixel electrodes) are used to perform partial display area displaying.

In the Embodiment 3, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Data 4˜6 are output from a source electrode driving circuit for the 4th˜6th lines of the partial display area. Voltage W for displaying an OFF color is output from the source electrode driving circuit for the 1st˜3rd and 7th˜8th lines of the Off area, in a refresh frame time period (in which the Off area is scanned or refreshed) and the source electrode driving circuit can output any data in a non-refresh frame time period (in which the Off area is not scanned or refreshed). In addition, dummy scan data D equivalent to the OFF-color voltage is output by the source electrode driving circuit for the dummy gates during the refresh frame time period. The source electrode driving circuit can output any data for the dummy gates during the non-refresh frame time period.

The color mode for the partial display area, for example, is an 8-color mode or full-color mode.

In the Embodiment 3, the common electrode voltage Vcom is used for line alternate-driving in a first scan period of the partial display area (i.e., in a first write period of the partial display area), and is used for frame alternate-driving in a second scan (or write) period of the Off area and the dummy gates (or in a second scan (or write) period outside of the partial display area). The common electrode voltage Vcom becomes the middle voltage during the non-refresh frame time period of the Off area and the dummy gates. In the frame alternate-driving period (the second write period outside of the partial display area), any of the two voltage durations (A, B) of the common electrode voltage Vcom respectively before and after the write period of the partial display area is adjusted to make the two voltage durations after adjusting become equal (A=B′), by tuning the duration (or length) of the high level or low level voltage period of the common electrode voltage Vcom.

Specifically, in the frame alternate-driving period (the second write period outside of the partial display area), the two voltage durations (A, B) of the common electrode voltage Vcom are of the same polarity and respectively before and after the write period of the partial display area, and a portion of the middle voltage period which follows the shorter one (the voltage duration B) of the two voltage durations (A, B), is replaced by a polarity voltage period, thereby obtaining an extending voltage duration (the voltage duration B′) to be equal to the voltage duration A. The polarity voltage period has the same polarity with that of the shorter voltage duration.

The method for driving the AMLCD according to the Embodiment 3 thus preventing stripe defects to occur in every other line (for n-line alternate-driving, stripe defects occur in every other n lines where n≧1 and is an integer).

In addition, the common electrode voltage is applied to combine the line alternate-driving and the frame alternate-driving, thus preventing flickers.

Furthermore, the common electrode voltage becomes the middle voltage during the non-refresh frame time period of the Off area and the dummy gates, according to the driving method as described in the Embodiment 3. Therefore, output variations (or transients) of pixel electrode scanning or data from the source electrode driving circuit can be kept at a minimum, thereby achieving reduction of power consumption.

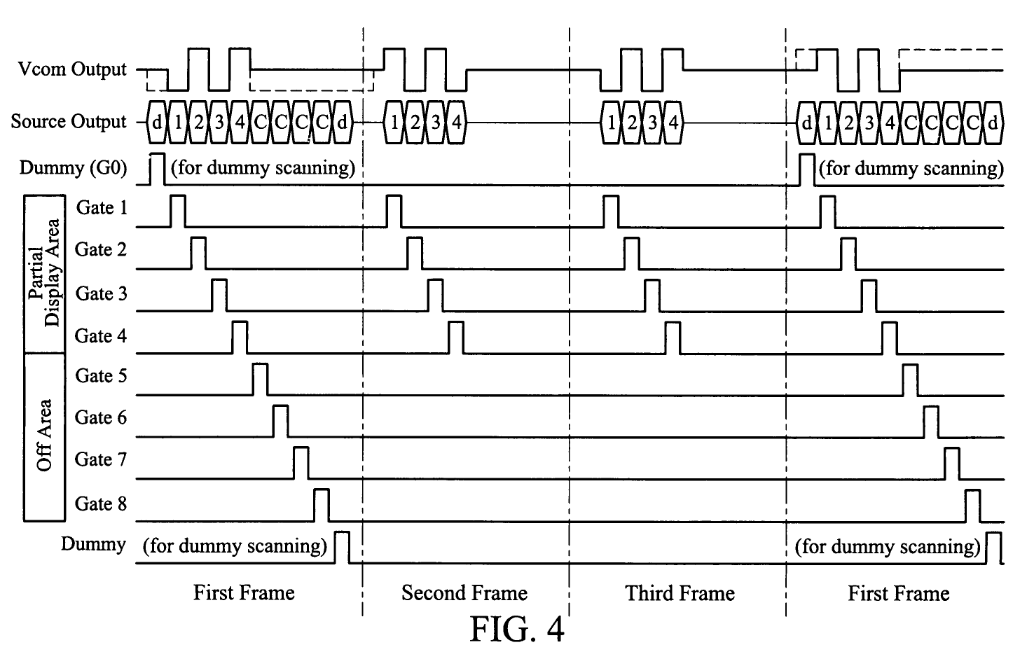

FIG. 4 is a timing chart showing signal (voltage) waveforms on electrodes of an AMLCD when performing partial display area displaying according to an Embodiment 4 of the invention.

In the Embodiment 4, 4 lines (the 1st to 4th lines) of the 8-line display area (8 lines of pixel electrodes) are used to perform partial display area displaying.

In the Embodiment 4, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Data 1˜4 are output from a source electrode driving circuit for the 1st˜4th lines of the partial display area. The voltage W for displaying an OFF color is not output and a source electrode middle voltage C is output from the source electrode driving circuit for the 5th˜8th lines of the Off area in a refresh frame time period (in which the Off area is scanned or refreshed) and the source electrode driving circuit can output any data in a non-refresh frame time period (in which the Off area is not scanned or refreshed). A middle voltage period is a period in which the level of a common electrode voltage is equal to a middle voltage of a positive common voltage and a negative common voltage.

In addition, Dummy scan data d equivalent to the source electrode middle voltage is output by the source electrode driving circuit for the dummy gates during the refresh frame time period. The source electrode driving circuit can output any data for the dummy gates during the non-refresh frame time period.

The reason why the source electrode middle voltage C is output for the 5th˜8th lines of the Off area and the dummy scan data d equivalent to the source electrode middle voltage is output for the 9th-line dummy gate during the refresh frame time period is described as follows. In the Embodiment 4, the common electrode voltage Vcom is not used for frame alternate-driving but becomes the middle voltage in a second scan (or write) period of the Off area and the dummy gates. Therefore, power saving can be achieved by outputting the source electrode middle voltage C and dummy scan data d for the pixel electrodes and dummy gates corresponding to the middle voltage period of the common electrode voltage.

The color mode for the partial display area, for example, is an 8-color mode or full-color mode.

In the Embodiment 4, the common electrode voltage Vcom is used for line alternate-driving in a first scan period of the partial display area (i.e., in a first write period of the partial display area), and becomes the middle voltage in a second scan (or write) period of the Off area and the dummy gates (or in a second scan (or write) period outside of the partial display area). The common electrode voltage also becomes the middle voltage during the non-refresh frame time period of the Off area and the dummy gates.

In other words, in the Embodiment 4 when the second write period outside of the partial display area is in the frame alternate-driving period, voltage durations (of the same polarity) respectively before and after the first write period of the partial display area are replaced by the middle voltage period; i.e., the high or low level voltage of the common electrode voltage in the voltage durations are replaced by the middle voltage. Consequently, the voltage durations respectively before and after the first write period of the partial display area have a positive or negative polarity periods of zero length.

Because, the two voltage durations of the common electrode voltage Vcom in the second write period of the Off area and the dummy gates are replaced by the middle voltage period, the dummy scan data d (i.e., the source electrode middle voltage), not the voltage equivalent to the OFF-color voltage, is applied to the dummy gates as described above. The source electrode middle voltage C is output by the source electrode driving circuit for the 5th˜8th lines of the Off area during the refresh frame time period, and not the voltage equivalent to the OFF-color voltage.

The method for driving the AMLCD according to the Embodiment 4 thus preventing stripe defects to occur in every other line (for n-line alternate-driving, stripe defects occur in every other n lines where n≧1 and is an integer).

In addition, the common electrode voltage is applied to combine the line alternate-driving and the frame alternate-driving, thus preventing flickers.

Furthermore, the common electrode voltage also becomes the middle voltage during the non-refresh frame time period of the Off area and the dummy gates, according to the driving method as described in the Embodiment 4. Therefore, output variations (or transients) of pixel electrode scanning or data from the source electrode driving circuit can be kept at a minimum, thereby achieving reduction of power consumption.

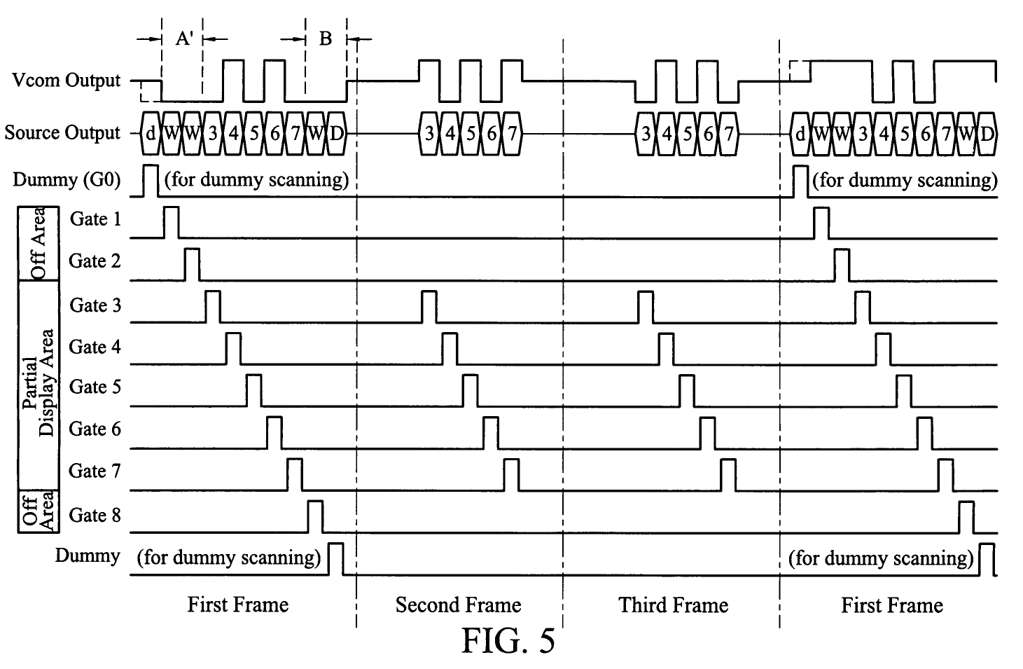

FIG. 5 is a timing chart showing signal (voltage) waveforms on electrodes of an AMLCD when performing partial display area displaying according to an Embodiment 5 of the invention.

In the Embodiment 5, 5 lines (the 3rd to 7th lines) of the 8-line display area (8 lines of pixel electrodes) are used to perform partial display area displaying. Originally, 4 (even) lines (3rd to 6th lines) are sufficient for partial display area displaying. Here, 5 (odd) lines (the 3rd to 7th lines) are used for partial display area displaying with an additional 7th line.

The main feature of the Embodiment 5 is to use odd number lines for partial display area displaying.

In the Embodiment 5, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Data 3˜7 are output from a source electrode driving circuit for the 3rd˜7th lines of the partial display area (for partial display area displaying). Voltage W for displaying an OFF color is output from the source electrode driving circuit for the 1st˜2nd and 8th lines of the Off area in a refresh frame time period (in which the Off area is scanned or refreshed) and the source electrode driving circuit can output any data in a non-refresh frame time period (in which the Off area is not scanned or refreshed).

Dummy scan data d equivalent to the source electrode middle voltage, not the voltage equivalent to the OFF-color voltage, is output by the source electrode driving circuit for the dummy gate (G0) provided before the initial (the 1st) line of the display area during the refresh frame time period. The reason to output the dummy scan data d (i.e., the source electrode middle voltage) for the (0th-line) dummy gate (G0) is the same as that described in the Embodiment 1. In addition, Dummy scan data D equivalent to the OFF-color voltage is output by the source electrode driving circuit for the (9th-line) dummy gate provided after the last (the 8th) line of the display area during the refresh frame time period. The source electrode driving circuit can output any data for the dummy gates during the non-refresh frame time period.

The color mode for the partial display area, for example, is an 8-color mode or full-color mode.

In the Embodiment 5, the common electrode voltage Vcom is used for line alternate-driving in a first scan period of the partial display area (i.e., in a first write period of the partial display area), and is used for frame alternate-driving in a second scan (or write) period of the Off area and the dummy gates (or in a second scan (or write) period outside of the partial display area). The common electrode voltage Vcom becomes the middle voltage during the non-refresh frame time period of the Off area and the dummy gates. In the frame alternate-driving period (i.e., the second write period outside of the partial display area), any of the two voltage durations of the common electrode voltage Vcom respectively before and after the write period of the partial display area is adjusted to make the two voltage durations after adjusting become equal (A′=B), by tuning the duration (or length) of the high level or low level voltage period of the common electrode voltage Vcom.

Specifically, in the frame alternate-driving period (i.e., the second write period outside of the partial display area), any of the two voltage durations (A, B) of the common electrode voltage Vcom which are of the same polarity and respectively before and after the write period of the partial display area, is replaced by the middle voltage period. Here, a portion of the voltage duration A (not shown in FIG. 5) is replaced by the middle voltage period and shrunk to a voltage duration A′, thereby achieving equal voltage durations A′ and B (A′=B).

Because, in the frame alternate-driving period of the common electrode voltage, a portion of one of the two voltage durations of the common electrode voltage Vcom which are of the same polarity and respectively before and after the write period of the partial display area, is replaced by the middle voltage period, the dummy scan data d (i.e., the source electrode middle voltage), not the voltage equivalent to the OFF-color voltage, is applied to the 0th-line dummy gate (G0) corresponding to the middle voltage period during the refresh frame time period.

The method for driving the AMLCD according to the Embodiment 5, using the same schemes as those of the embodiments 1˜3, thus preventing stripe defects to occur in every other line (for n-line alternate-driving, stripe defects occur in every other n lines where n≧1 and is an integer). The pixel electrodes serving as the partial display area are set to have an odd number of lines, and thus number (or times) of inversions for the holding operation of each line will become even, thereby obtaining balance of polarity inversion. Consequently, hindering generation of stripe defects in the AMLCD.

In addition, the common electrode voltage is applied to combine the line alternate-driving and the frame alternate-driving, thus preventing flickers.

Furthermore, the common electrode voltage becomes the middle voltage during the non-refresh frame time period of the Off area and the dummy gates, according to the driving method as described in the Embodiment 5. Therefore, output variations (or transients) of pixel electrode scanning or data from the source electrode driving circuit can be kept at a minimum during the non-refresh frame time period, thereby achieving reduction of power consumption.

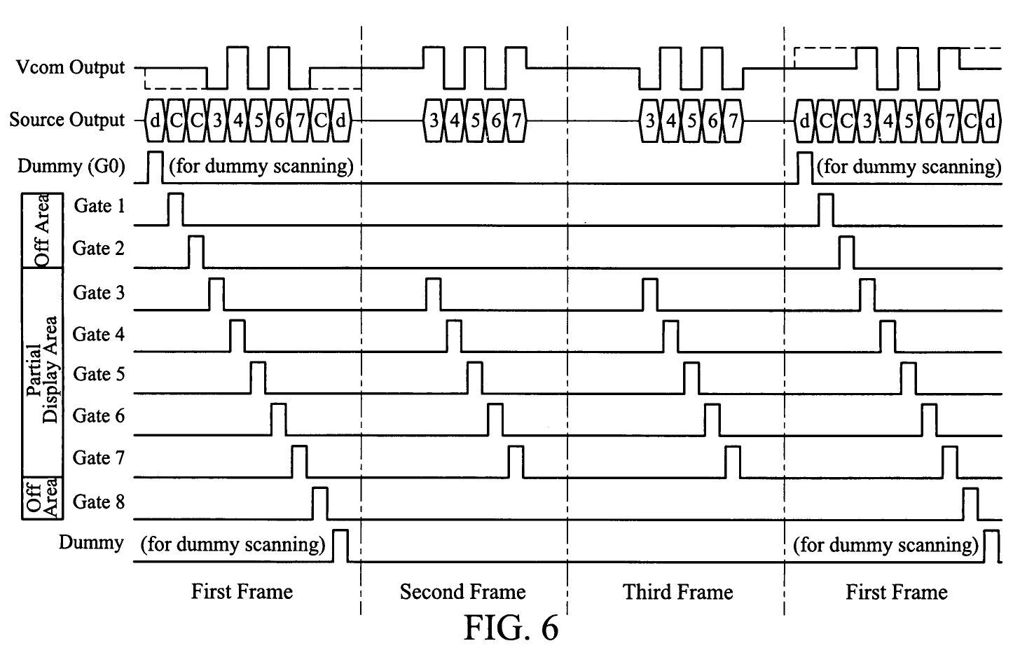

FIG. 6 is a timing chart showing signal (voltage) waveforms on electrodes of an AMLCD when performing partial display area displaying according to an Embodiment 6 of the invention.

In the Embodiment 6, 5 lines (the 3rd to 7th lines) of the 8-line display area (8 lines of pixel electrodes) are used to perform partial display area displaying. Originally, 4 (even) lines (3rd to 6th lines) are sufficient for partial display area displaying. Here, 5 (odd) lines (the 3rd to 7th lines) are used for partial display area displaying with an additional 7th line.

One feature of the Embodiment 6, which is the same as that described in the Embodiment 5, is to set the pixel electrodes for the partial display area to have an odd number of lines. Another feature of the Embodiment 6 is to perform driving of the common electrode voltage, which is the same as that described in the Embodiment 4, and will be described hereinafter.

In the Embodiment 6, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed).

Data 3˜7 are output from a source electrode driving circuit for the 3rd˜7th lines of the partial display area. A source electrode middle voltage C is output from the source electrode driving circuit for the 1st˜2nd and 8th lines of the Off area in a refresh frame time period (in which the Off area is scanned or refreshed) and not the voltage W for displaying an OFF color, and the source electrode driving circuit can output any data in a non-refresh frame time period (in which the Off area is not scanned or refreshed). A middle voltage period is a period in which the level of a common electrode voltage is equal to a middle voltage of a positive common voltage and a negative common voltage.

In addition, Dummy scan data d equivalent to the source electrode middle voltage, not the voltage equivalent to the OFF-color voltage, is output by the source electrode driving circuit for the dummy gates during the refresh frame time period. The source electrode driving circuit can output any data for the dummy gates during the non-refresh frame time period.

The reason why the source electrode middle voltage C is output for the 5th˜8th lines of the Off area and the dummy scan data d equivalent to the source electrode middle voltage is output for the 9th-line dummy gate during the refresh frame time period has been described in the Embodiment 4.

The color mode for the partial display area, for example, is an 8-color mode or full-color mode.

In the Embodiment 6, the same as the Embodiment 4, the common electrode voltage Vcom is used for line alternate-driving in a first scan period of the partial display area (i.e., in a first write period of the partial display area), and, is not used for frame alternate-driving. The common electrode voltage Vcom becomes the middle voltage in a second scan (or write) period of the Off area and the dummy gates or in a second scan (or write) period outside of the partial display area. The common electrode voltage also becomes the middle voltage during the non-refresh frame time period of the Off area and the dummy gates.

In other words, in the Embodiment 6 when the second write period outside of the partial display area is in the frame alternate-driving period, voltage durations (of the same polarity) respectively before and after the first write period of the partial display area are replaced by the middle voltage period; i.e., the high or low level voltage of the common electrode voltage in the voltage durations are replaced by the middle voltage. Consequently, the voltage durations respectively before and after the first write period of the partial display area have a positive or negative polarity period of zero length.

Because, the two voltage durations of the common electrode voltage Vcom in the second write period of the Off area and the dummy gates are replaced by the middle voltage period, the dummy scan data d (i.e., the source electrode middle voltage), not the voltage equivalent to the OFF-color voltage, is applied to the dummy gates as described above. Not the voltage equivalent to the OFF-color voltage but the source electrode middle voltage C is output by the source electrode driving circuit for the 1st˜2nd and 8th lines of the Off area during the refresh frame time period.

The method for driving the AMLCD according to the Embodiment 6, using the same schemes such as that in Embodiment 5, thus preventing stripe defects to occur in every other line (for n-line alternate-driving, stripe defects occur in every other n lines where n≧1 and is an integer). The pixel electrodes serving as the partial display area are set to have an odd number of lines, and thus number (or times) of inversions for the holding operation of each line will become even, thereby obtaining balance of polarity inversion. Consequently, hindering generation of stripe defects in the AMLCD.

In addition, the common electrode voltage is applied to combine the line alternate-driving and the frame alternate-driving, thus preventing flickers.

Furthermore, the common electrode voltage also becomes the middle voltage during the non-refresh frame time period of the Off area and the dummy gates, according to the driving method as described in the Embodiment 6. Therefore, output variations (or transients) of pixel electrode scanning or data from the source electrode driving circuit can be kept at a minimum during the non-refresh frame time period, thereby achieving reduction of power consumption.

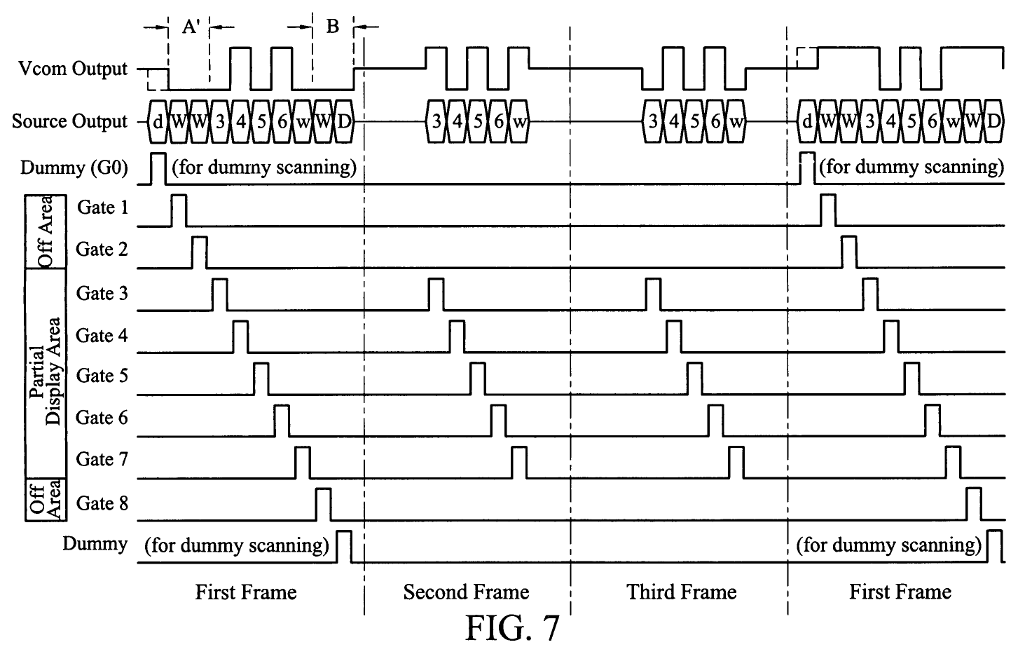

FIG. 7 is a timing chart showing signal (voltage) waveforms on electrodes of an AMLCD when performing partial display area displaying according to an Embodiment 7 of the invention.

In the Embodiment 7, 5 lines (the 3rd to 7th lines) of the 8-line display area (8 lines of pixel electrodes) are used to perform partial display area displaying. Originally, 4 (even) lines (3rd to 6th lines) are sufficient for partial display area displaying. Here, 5 (odd) lines (the 3rd to 7th lines) are used for partial display area displaying with an additional 7th line.

The feature of the Embodiment 7, which is the same as that described in the Embodiment 5, uses an odd number of lines for partial display area displaying.

In the Embodiment 7, a practical image data of the 7th line (pixel electrode) in the partial display area is not necessarily required. As described hereinafter, the OFF-color line data (w) equivalent to the OFF-color voltage is output from the source electrode driving circuit for the 7th line of the partial display area; which is the main difference between the Embodiments 7 and 5.

In the Embodiment 7, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed). Moreover, the 7th line of the partial display area serves as a portion of the partial display area and is also scanned.

Data 3˜6 are output from a source electrode driving circuit for the 3rd˜6th lines of the partial display area (3rd˜7th lines) for partial display area displaying. Meanwhile, practical image data of the OFF-color line data w equivalent to the OFF-color voltage output for the 7th line, as described above, is not necessarily required. Voltage W for displaying an OFF color is output from the source electrode driving circuit for the 1st˜2nd and 8th lines of the Off area in a refresh frame time period (in which the Off area is scanned or refreshed) and the source electrode driving circuit can output any data in a non-refresh frame time period (in which the Off area is not scanned or refreshed).

Dummy scan data d equivalent to the source electrode middle voltage, not the voltage equivalent to the OFF-color voltage, is output by the source electrode driving circuit for the dummy gate (G0) provided before the initial (the 1st) line of the display area during the refresh frame time period. The reason to output the dummy scan data d (i.e., the source electrode middle voltage) for the (0th-line) dummy gate (G0) is the same as that described in the Embodiment 1. In addition, Dummy scan data D equivalent to the OFF-color voltage is output by the source electrode driving circuit for the (9th-line) dummy gate provided after the last (the 8th) line of the display area during the refresh frame time period. The source electrode driving circuit can output any data for the dummy gates during the non-refresh frame time period.

The color mode for the partial display area, for example, is an 8-color mode or full-color mode.

In the Embodiment 7, the same as the Embodiment 5, the common electrode voltage Vcom is used for line alternate-driving in a first scan period of the partial display area (i.e., in a first write period of the partial display area), and is used for frame alternate-driving in a second scan (or write) period of the Off area and the dummy gates or in a second scan (or write) period outside of the partial display area. The common electrode voltage Vcom becomes the middle voltage during the non-refresh frame time period of the Off area and the dummy gates. In the frame alternate-driving period (i.e., the second write period outside of the partial display area), any of the two voltage durations of the common electrode voltage Vcom respectively before and after the write period of the partial display area is adjusted to make the two voltage durations after adjusting become equal (A′=B), by tuning the duration (or length) of the high level or low level voltage period of the common electrode voltage Vcom.

Specifically, in the frame alternate-driving period (i.e., the second write period outside of the partial display area), the longer one of the two voltage durations of the common electrode voltage Vcom which are of the same polarity and respectively before and after the write period of the partial display area, is replaced by the middle voltage period. Here, a portion of the voltage duration A (not shown in FIG. 5) is replaced by the middle voltage period and shrunk to a voltage duration A′, thereby achieving equal voltage durations A′ and B (A′=B).

Because, in the frame alternate-driving period of the common electrode voltage, a portion of one of the two voltage durations of the common electrode voltage Vcom which are of the same polarity and respectively before and after the write period of the partial display area, is replaced by the middle voltage period, the dummy scan data d (i.e., the source electrode middle voltage), not the voltage equivalent to the OFF-color voltage, is applied to the 0th-line dummy gate (G0) corresponding to the middle voltage period during the refresh frame time period.

The method for driving the AMLCD according to the Embodiment 7, uses the same schemes as that in the Embodiment 5, with the exception that the 7th line is used for the display OFF color, thus preventing stripe defects to occur in every other line (for n-line alternate-driving, stripe defects occur in every other n lines where n≧1 and is an integer). The pixel electrodes serving as the partial display area are set to have an odd number of lines, and thus number (or times) of inversions for the holding operation of each line will become even, thereby obtaining balance of polarity inversion. Consequently, hindering generation of stripe defects in the AMLCD.

In addition, the common electrode voltage is applied to combine the line alternate-driving and the frame alternate-driving, thus preventing flickers.

Furthermore, the common electrode voltage becomes the middle voltage during the non-refresh frame time period of the Off area and the dummy gates, according to the driving method as described in the Embodiment 7. Therefore, output variations (or transients) of pixel electrode scanning or data from the source electrode driving circuit can be kept at a minimum during the non-refresh frame time period, thereby achieving reduction of power consumption.

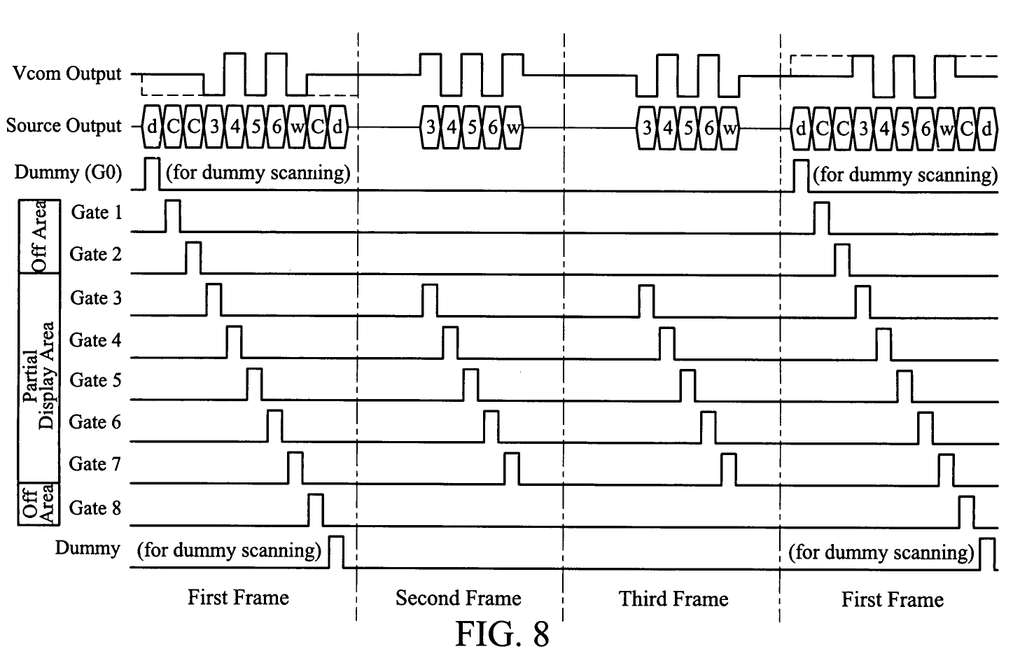

FIG. 8 is a timing chart showing signal (voltage) waveforms on electrodes of an AMLCD when performing partial display area displaying according to an Embodiment 8 of the invention.

In the Embodiment 8, 5 lines (the 3rd to 7th lines) of the 8-line display area (8 lines of pixel electrodes) are used to perform partial display area displaying. Originally, 4 (even) lines (3rd to 6th lines) are sufficient for partial display area displaying. Here, 5 (odd) lines (the 3rd to 7th lines) are used for partial display area displaying with an additional 7th line.

One feature of the Embodiment 8, which is the same as that described in the Embodiments 5 and 6, is to set the pixel electrodes for the partial display area to have an odd number of lines.

In the Embodiment 8, similar with the Embodiment 7, a practical image data of the 7th line (pixel electrode) in the partial display area is not necessarily required. As described hereinafter, the OFF-color line data (w) equivalent to the OFF-color voltage is output from the source electrode driving circuit for the 7th line of the partial display area.

In the Embodiment 8, refresh rate for an Off area is ⅓ times that of a partial display area. Therefore, all pixel electrodes and dummy electrodes are sequentially scanned in a first frame time period (in which the Off area is refreshed), and only pixel electrodes on the partial display area are sequentially scanned in a second and third frame time period (in which the Off area is not refreshed). Moreover, the 7th line of the partial display area serves as a portion of pixel electrodes in the partial display area and is also scanned.

Data 3˜6 are output from a source electrode driving circuit for the 3rd˜6th lines of the partial display area (3rd˜7th lines) for partial display area displaying. Meanwhile, practical image data for the OFF-color line data w equivalent to the OFF-color voltage output for the 7th line, as described above, is not necessarily required. The source electrode middle voltage C, not voltage W for displaying an OFF color, is output from the source electrode driving circuit for the 1st˜2nd and 8th lines of the Off area in a refresh frame time period (in which the Off area is scanned or refreshed), and the source electrode driving circuit can output any data in a non-refresh frame time period (in which the Off area is not scanned or refreshed).

Dummy scan data d equivalent to the source electrode middle voltage, not the voltage equivalent to the OFF-color voltage, is output by the source electrode driving circuit for the dummy gates during the refresh frame time period. The source electrode driving circuit can output any data for the dummy gates during the non-refresh frame time period.

The reason to output the source electrode middle voltage C (i.e., the source electrode middle voltage) for the 1st˜2nd and 8th lines of the Off area and output the dummy scan data d (i.e., the source electrode middle voltage) has been described in the Embodiment 4.

The color mode for the partial display area, for example, is an 8-color mode or full-color mode.

In the Embodiment 8, the same as the Embodiment 6, the common electrode voltage Vcom is used for line alternate-driving in a first scan period of the partial display area (i.e., in a first write period of the partial display area); and, not used for frame alternate-driving. Vcom becomes the middle voltage in a second scan (or write) period of the Off area and the dummy gates or in a second scan (or write) period outside of the partial display area. The common electrode voltage also becomes the middle voltage during the non-refresh frame time period of the Off area and the dummy gates.

In other words, in the Embodiment 8 when the second write period outside of the partial display area is in the frame alternate-driving period, voltage durations (of the same polarity) respectively before and after the first write period of the partial display area are replaced by the middle voltage period; i.e., the high or low level voltage of the common electrode voltage in the voltage durations are replaced by the middle voltage. Consequently, the voltage durations respectively before and after the first write period of the partial display area have a positive or negative polarity period of zero length.

Because, the two voltage durations of the common electrode voltage Vcom in the second write period of the Off area and the dummy gates are replaced by the middle voltage period, the dummy scan data d (i.e., the source electrode middle voltage), not the voltage equivalent to the OFF-color voltage, is applied to the dummy gates as described above. The source electrode middle voltage C is output by the source electrode driving circuit for the 1st˜2nd and 8th lines of the Off area during the refresh frame time period, and not the voltage equivalent to the OFF-color voltage.

The method for driving the AMLCD according to the Embodiment 8, uses the same schemes such as those in Embodiment 6, with the exception that the 7th line of the partial display area is used for displaying an OFF color, thus preventing stripe defects to occur in every other line (for n-line alternate-driving, stripe defects occur in every other n lines where n≧1 and is an integer). The pixel electrodes serving as the partial display area are set to have an odd number of lines, and thus number (or times) of inversions for the holding operation of each line will become even, thereby obtaining balance of polarity inversion. Consequently, generation of stripe defects is avoided in the AMLCD.

In addition, the common electrode voltage is applied to combine the line alternate-driving and the frame alternate-driving, thus preventing flickers.

Furthermore, the common electrode voltage also becomes the middle voltage during the non-refresh frame time period of the Off area and the dummy gates, according to the driving method as described in the Embodiment 8. Therefore, output variations (or transients) of pixel electrode scanning or data from the source electrode driving circuit can be kept at a minimum during the non-refresh frame time period, thereby achieving reduction of power consumption.

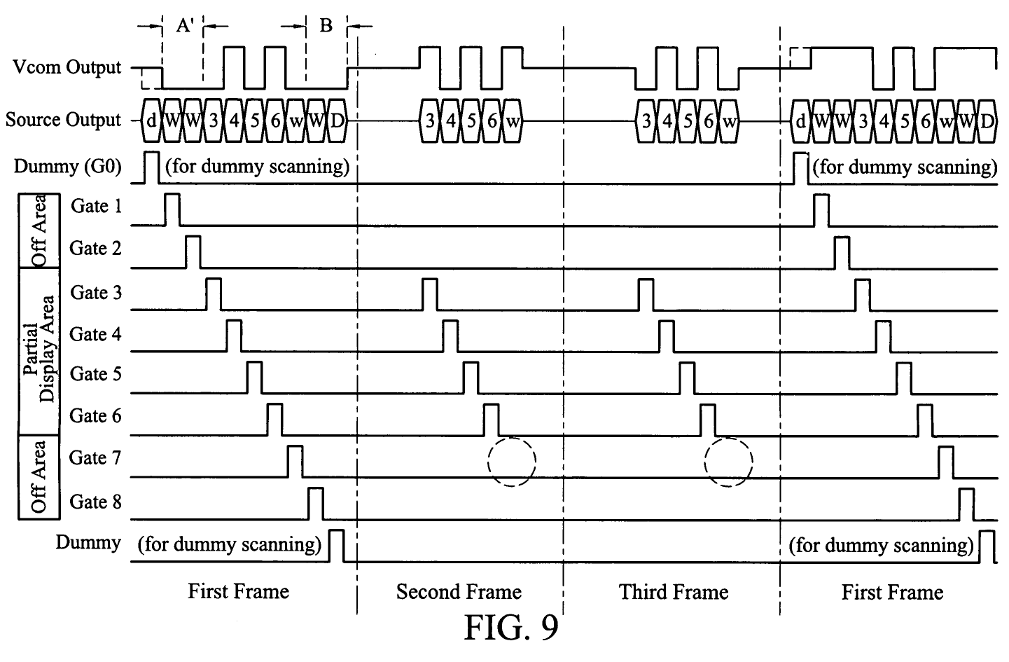

FIG. 9 is a timing chart showing signal (voltage) waveforms on electrodes of an AMLCD when performing partial display area displaying according to an Embodiment 9 of the invention.

In the Embodiment 9, 5 lines (the 3rd to 7th lines) of the 8-line display area (8 lines of pixel electrodes) are used to perform partial display area displaying. Originally, 4 (even) lines (3rd to 6th lines) are sufficient for partial display area displaying. Here, 5 (odd) lines (the 3rd to 7th lines) are used for partial display area displaying with an additional 7th line.

The feature of the Embodiment 9, which is the same as that described in the Embodiment 7, uses an odd number of lines for partial display area displaying.

In the Embodiment 9, a practical image data of the additional 7th line (pixel electrode) in the partial display area is not necessarily required. As described hereinafter, OFF-color line data (w) equivalent to the OFF-color voltage is output from the source electrode driving circuit for the 7th line of the partial display area.

In the Embodiment 9, the additional 7th line (pixel electrode) of the partial display area is not scanned during the non-refresh frame time period of the Off area. The 7th line (pixel electrode) only performs OFF color displaying along with the Off area. Thus, the 7th line is not scanned, and image displaying is not affected. Power saving can be achieved by omitting scanning of one line (pixel electrode).

In the Embodiment 9, refresh rate for an Off area is ⅓ times that of a partial display area. Therefore, all pixel electrodes and dummy electrodes are sequentially scanned in a first frame time period (in which the Off area is refreshed), and only pixel electrodes (3rd˜6th lines) on the partial display area, with the exception of the 7th line for setting the partial display area to have an odd number of lines, are sequentially scanned in a second and third frame time period (in which the Off area is not refreshed).

Data 3˜6 are output from a source electrode driving circuit for the 3rd˜6th lines of the partial display area (3rd˜7th lines) for partial display area displaying. Meanwhile, practical image data of the OFF-color line data w equivalent to the OFF-color voltage output for the 7th line, as described above, is not necessarily required. Voltage W for displaying an OFF color is output from the source electrode driving circuit for the 1st˜2nd and 8th lines of the Off area, in a refresh frame time period (in which the Off area is scanned or refreshed) and the source electrode driving circuit can output any data in a non-refresh frame time period (in which the Off area is not scanned or refreshed).

Dummy scan data d equivalent to the source electrode middle voltage, not the voltage equivalent to the OFF-color voltage, is output by the source electrode driving circuit for the dummy gate (G0) provided before the initial (the 1st) line of the display area during the refresh frame time period. The reason to output the dummy scan data d (i.e., the source electrode middle voltage) for the (0th-line) dummy gate (G0) is the same as that described in the Embodiment 1. In addition, Dummy scan data D equivalent to the OFF-color voltage is output by the source electrode driving circuit for the (9th-line) dummy gate provided after the last (the 8th) line of the display area during the refresh frame time period. The source electrode driving circuit can output any data for the dummy gates during the non-refresh frame time period.

The color mode for the partial display area, for example, is an 8-color mode or full-color mode.

In the Embodiment 9, the same as the Embodiment 7, the common electrode voltage Vcom is used for line alternate-driving in a first scan period of the partial display area (i.e., in a first write period of the partial display area) and in a period corresponding to an additional OFF-color line (i.e., the 7th line), and is used for frame alternate-driving in a second scan (or write) period of the Off area and the dummy gates (or in a second scan (or write) period outside of the partial display area). The common electrode voltage Vcom becomes the middle voltage during the non-refresh frame time period of the Off area and the dummy gates. In the frame alternate-driving period (i.e., the second write period outside of the partial display area), any of the two voltage durations of the common electrode voltage Vcom respectively before and after the write period of the partial display area is adjusted to make the two voltage durations after adjusting become equal (A′=B), by tuning the duration (or length) of the high level or low level voltage period of the common electrode voltage Vcom.

Specifically, in the frame alternate-driving period (i.e., the second write period outside of the partial display area), the longer one of the two voltage durations of the common electrode voltage Vcom which are of the same polarity and respectively before and after the write period of the partial display area, is replaced by the middle voltage period. Here, a portion of the voltage duration A (not shown in FIG. 5) is replaced by the middle voltage period and shrunk to a voltage duration A′, thereby achieving equal voltage durations A′ and B (A′=B).

Because, in the frame alternate-driving period of the common electrode voltage, a portion of one of the two voltage durations of the common electrode voltage Vcom which are of the same polarity and respectively before and after the write period of the partial display area, is replaced by the middle voltage period, the dummy scan data d (i.e., the source electrode middle voltage), not the voltage equivalent to the OFF-color voltage, is applied to the 0th-line dummy gate (G0) corresponding to the middle voltage period during the refresh frame time period.

The method for driving the AMLCD according to the Embodiment 9 uses the same schemes as that in the Embodiment 7, with the exception that the 7th line is not scanned to display the OFF color during the non-refresh frame time period of the Off area. Using the method of the Embodiment 9, stripe defects are prevented from occurring in every other line (for n-line alternate-driving, stripe defects occur in every other n lines where n≧1 and is an integer). The pixel electrodes serving as the partial display area are set to have an odd number of lines, and thus number (or times) of inversions for the holding operation of each line will become even, thereby obtaining balance of polarity inversion. Consequently, hindering generation of stripe defects in the AMLCD.

In addition, the common electrode voltage is applied to combine the line alternate-driving and the frame alternate-driving, thus preventing flickers.

Furthermore, the common electrode voltage becomes the middle voltage during the non-refresh frame time period of the Off area and the dummy gates, according to the driving method as described in the Embodiment 9. Therefore, output variations (or transients) of pixel electrode scanning or data from the source electrode driving circuit can be kept at a minimum during the non-refresh frame time period and one line scanning for pixel electrode is further omitted during the non-refresh frame time period of the Off area, thereby achieving reduction of power consumption.

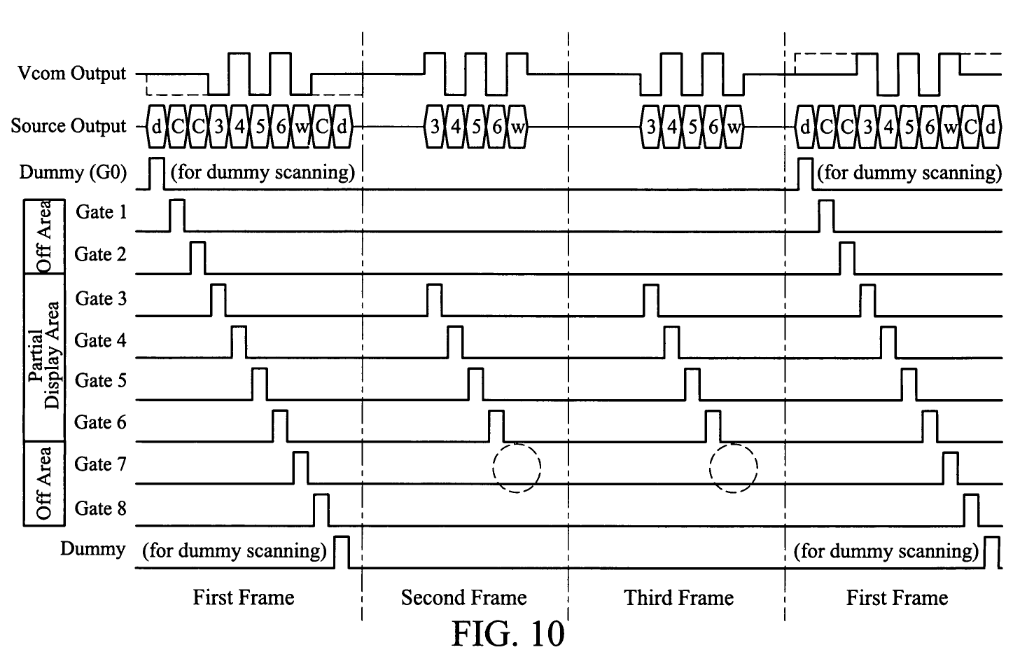

FIG. 10 is a timing chart showing signal (voltage) waveforms on electrodes of an AMLCD when performing partial display area displaying according to an Embodiment 10 of the invention.

In the Embodiment 10, the same schemes as described in the Embodiments 5 and 6, wherein 5 lines (the 3rd to 7th lines) of the 8-line display area (8 lines of pixel electrodes) are used to perform partial display area displaying, are used. Originally, 4 (even) lines (3rd to 6th lines) are sufficient for partial display area displaying. Here, 5 (odd) lines (the 3rd to 7th lines) are used for partial display area displaying with an additional 7th line.

The feature of the Embodiment 10, the same as those of the Embodiments 5 and 6, is to use an odd number of lines for partial display area displaying.

In the Embodiment 10, the same as the Embodiments 7 and 8, practical image data of the additional 7th line (pixel electrode) in the partial display area is not necessarily required. As described hereinafter, the OFF-color line data (w) equivalent to the OFF-color voltage is output from the source electrode driving circuit for the 7th line of the partial display area.

In the Embodiment 10, the same as the Embodiment 9, the additional 7th line (pixel electrode) of the partial display area is not scanned during the non-refresh frame time period of the Off area. The 7th line (pixel electrode) only performs OFF color displaying along with the operation of the Off area. Thus, the 7th line is not scanned, and image displaying is not affected. Power saving can be achieved by omitting scanning of one line (pixel electrode). The above description is the main difference between the Embodiment 10 and 8.

In the Embodiment 10, refresh rate for an Off area is ⅓ times that of a partial display area. Therefore, all pixel electrodes and dummy electrodes are sequentially scanned in a first frame time period (in which the Off area is refreshed), and only pixel electrodes (3rd˜6th lines) on the partial display area, with the exception of the 7th line for setting the partial display area to have an odd number of lines, are sequentially scanned in a second and third frame time period (in which the Off area is not refreshed).

Data 3˜6 are output from a source electrode driving circuit for the 3rd˜6th lines of the partial display area (3rd˜7th lines) for partial display area displaying. Meanwhile, practical image data of the OFF-color line data w equivalent to the OFF-color voltage output for the 7th line, as described above, is not necessarily required. In addition, the source electrode middle voltage C, not the voltage W for displaying an OFF color, is output from the source electrode driving circuit for the 1st˜2nd and 8th lines of the Off area, in a refresh frame time period (in which the Off area is scanned or refreshed), and the source electrode driving circuit can output any data in a non-refresh frame time period (in which the Off area is not scanned or refreshed).

Dummy scan data d equivalent to the source electrode middle voltage, not the voltage equivalent to the OFF-color voltage, is output by the source electrode driving circuit for the dummy gates during the refresh frame time period. The source electrode driving circuit can output any data for the dummy gates during the non-refresh frame time period.

The reason to output the source electrode middle voltage C for the 1st˜2nd and 8th lines of the Off area and to output the dummy scan data d (i.e., the source electrode middle voltage) for the dummy gates has been described in the Embodiment 4.

The color mode for the partial display area, for example, is an 8-color mode or full-color mode.

In the Embodiment 10, the same as the embodiments 6 and 8, the common electrode voltage Vcom is used for line alternate-driving in a first scan period of the partial display area (i.e., in a first write period of the partial display area) and in a period corresponding to an additional OFF-color line (i.e., the 7th line), and becomes the middle voltage, not used for frame alternate-driving, in a second scan (or write) period of the Off area and the dummy gates (or in a second scan (or write) period outside of the partial display area). The common electrode voltage Vcom becomes the middle voltage during the non-refresh frame time period of the Off area and the dummy gates.

In other words, in the Embodiment 10 when the second write period outside of the partial display area is in the frame alternate-driving period, voltage durations (of the same polarity) respectively before and after the first write period of the partial display area are replaced by the middle voltage period; i.e., the high or low level voltage of the common electrode voltage in the voltage durations are replaced by the middle voltage. Consequently, the voltage durations respectively before and after the first write period of the partial display area have a positive or negative polarity period of zero length.

Because the common electrode voltage Vcom is replaced by the middle voltage in the second write period of the Off area and the dummy gates, as described above, the dummy scan data d (i.e., the source electrode middle voltage) is output for the dummy gates corresponding to the middle voltage period during the refresh frame time period, and not the voltage equivalent to the OFF-color voltage. Also, the source electrode middle voltage C, not the voltage W for displaying the OFF color, is output for the 1st˜2nd and 8th lines of the Off area during the refresh frame time period.

The method for driving the AMLCD according to the Embodiment 10 uses the same schemes as that in the Embodiment 8, with the exception that the 7th line is not scanned to display the OFF color during the non-refresh frame time period of the Off area. Using the method of the Embodiment 10 stripe defects are prevented from occurring in every other line (for n-line alternate-driving, stripe defects occur in every other n lines where n≧1 and is an integer). The pixel electrodes serving as the partial display area are set to have an odd number of lines, and thus number (or times) of inversions for the holding operation of each line will become even, thereby obtaining balance of polarity inversion. Consequently, hindering generation of stripe defects in the AMLCD.

In addition, the common electrode voltage is applied to combine the line alternate-driving and the frame alternate-driving, thus preventing flickers.

Furthermore, the common electrode voltage becomes the middle voltage during the non-refresh frame time period of the Off area and the dummy gates, according to the driving method as described in the Embodiment 9. Therefore, output variations (or transients) of pixel electrode scanning or data from the source electrode driving circuit can be kept at a minimum during the non-refresh frame time period and one line scanning for pixel electrode is further omitted during the non-refresh frame time period of the Off area, thereby achieving reduction of power consumption.

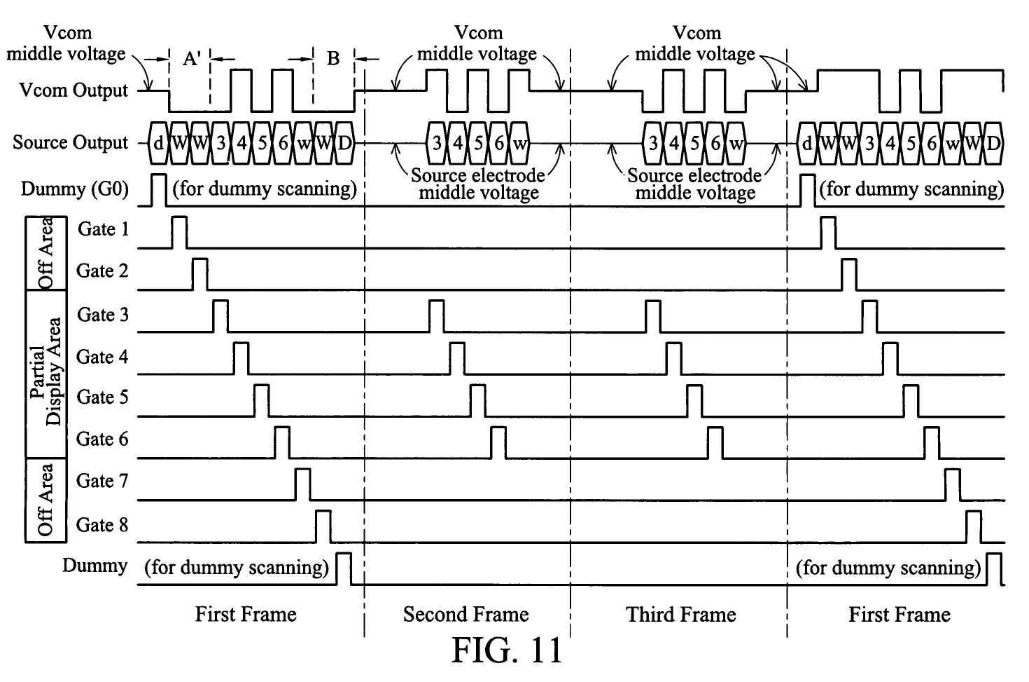

FIG. 11 is a timing chart showing signal (voltage) waveforms on electrodes of an AMLCD when performing partial display area displaying according to an Embodiment 11 of the invention.

Comparing the timing charts of the Embodiments 11 and 9, they have the same driving schemes.

As such, in the Embodiment 11, the description of making the common electrode voltage Vcom become the middle voltage and using the source electrode middle voltage (i.e., the middle voltage of the source electrode as described in the Embodiment 1) during the non-refresh frame time period of the Off area in the Embodiment 9 is emphasized as a portion of the invention.

The reason to adopt the schemes of the Embodiments 9 and 11 is described as follows. When capacitance coupling between the pixel electrode and the source bus is considered during the non-refresh frame time period of the Off area, a middle (write) voltage of positive write voltage and negative write voltage is preferred to be applied to the source electrode. When charge leaking between the pixel electrode and the common electrode is considered during the non-refresh frame time period of the Off area, a middle voltage of positive common voltage and negative common voltage is preferred to be applied to the common electrode.

The middle (write) voltage (i.e., the source electrode middle voltage) to be applied to the source electrode can be replaced by an approximate voltage such as the middle voltage of the common electrode voltage.

In the Embodiment 11, power saving is achieved by suppressing or preventing the capacitance coupling effect between the pixel electrode and the source bus.

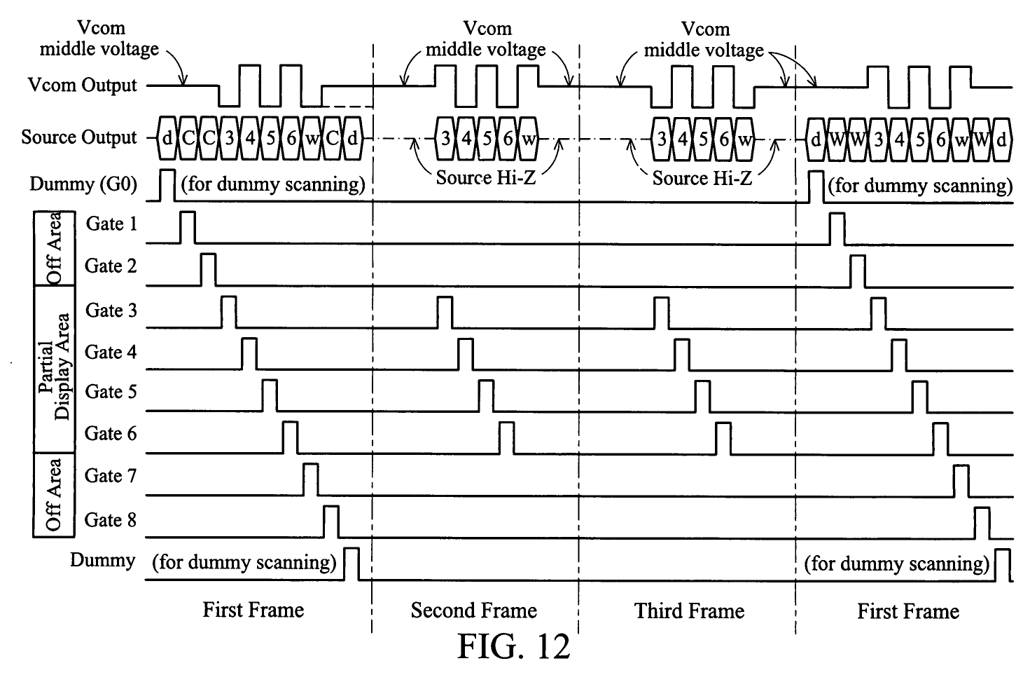

FIG. 12 is a timing chart showing signal (voltage) waveforms on electrodes of an AMLCD when performing partial display area displaying according to an Embodiment 12 of the invention.

In the Embodiment 12, the common electrode voltage becomes the middle voltage during the non-refresh frame time period of the Off area, the same as that described in the Embodiment 10. However, during the non-refresh frame time period of the Off area, the source electrode middle voltage is not applied to the source electrode by the source electrode driving circuit and the output of the source electrode driving circuit is set to high impedance (Hi-Z).

When power saving is the most concerning issue, the output of the source electrode driving circuit is preferred to be set to the high impedance (Hi-Z) during the non-refresh frame time period of the Off area.

Power saving can be achieved by using the scheme as described in the Embodiment 12.

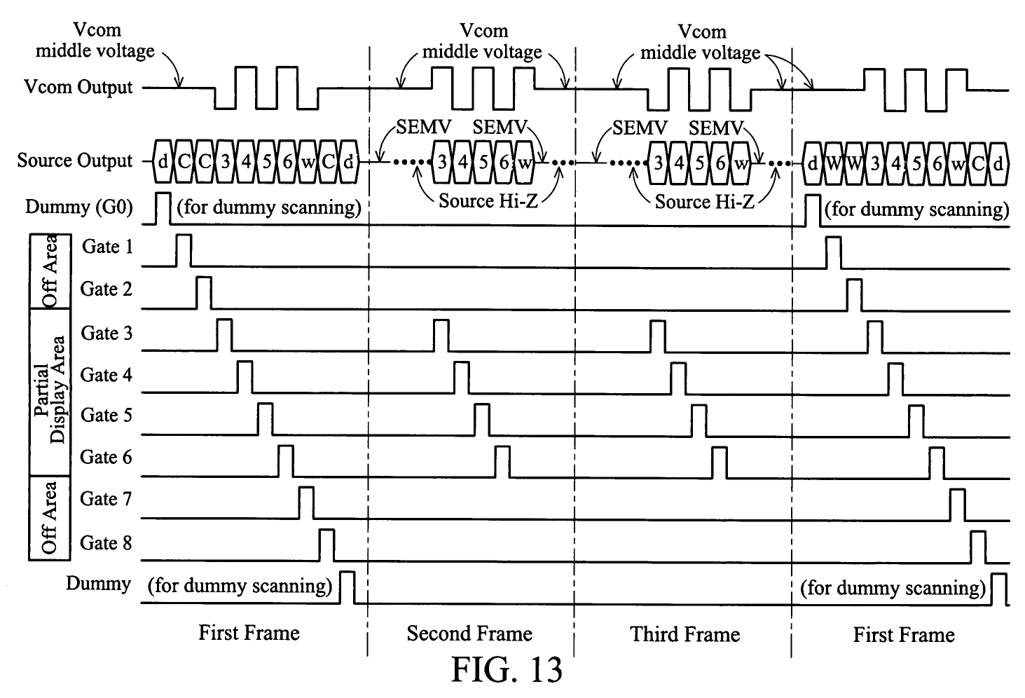

FIG. 13 is a timing chart showing signal (voltage) waveforms on electrodes of an AMLCD when performing partial display area displaying according to an Embodiment 13 of the invention.

The Embodiment 13 is the combination of the Embodiments 11 and 12.

When capacitance coupling between the pixel electrode and the source bus is considered during the non-refresh frame time period of the Off area, the middle (write) voltage of positive write voltage and negative write voltage is preferred to be applied to the source electrode. When power saving is considered during the non-refresh frame time period of the Off area, the output of the source electrode driving circuit is preferred to set to high impedance (Hi-Z).

Consequently, in the Embodiment 13, during the non-refresh frame time period of the Off area, the middle (write) voltage of positive write voltage and negative write voltage is first applied to the source electrode, and then the output of the source electrode driving circuit is set to high impedance (Hi-Z). Here, the source electrode middle voltage is indicated by the notation ‘SEMV’ in FIG. 13.

Power saving can be achieved by using the scheme as described in the Embodiment 13 and by suppressing the capacitance coupling between the pixel electrode and the source bus.

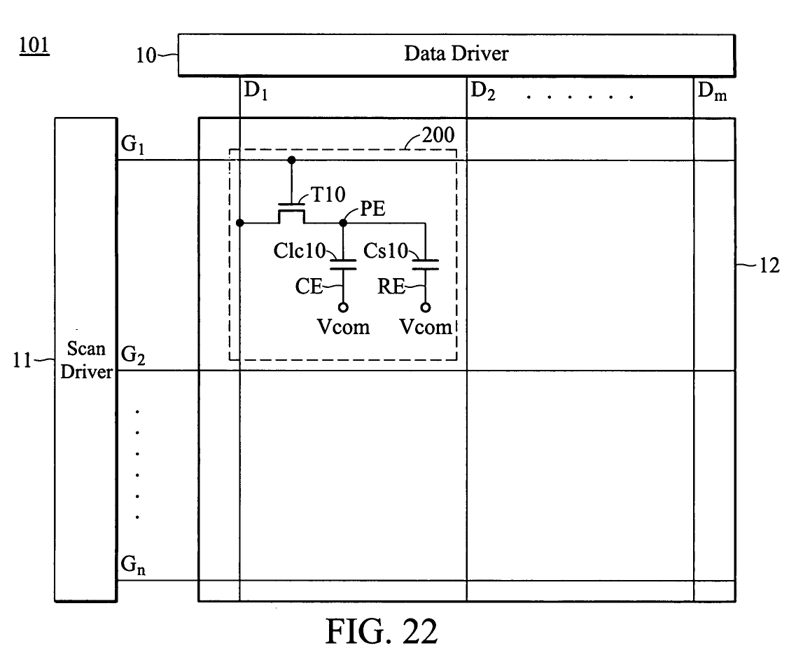

FIG. 22 shows a schematic circuit diagram of an active matrix liquid crystal display (AMLCD). The AMLCD can operate according to the AMLCD driving methods described in the embodiments of the invention.

The AMLCD 101 comprises a plurality of pixels 200 provided in an array form on a display area of a transparent glass substrate, wherein a pixel electrode PE and a common electrode CE formed opposed to the pixel electrode PE are further provided in each of the pixels 200, and the common electrode CE is formed on the other transparent glass substrate. A scan driver 11 performs scanning of the pixel electrode, specifically, to perform scanning of a control node of a transistor T10 coupled to the pixel electrode PE. Meanwhile, a data driver 10 serving as a source electrode driving circuit, outputs write voltages to the pixel electrode PE through the source electrode.

The AMLCD having the structure described above is driven by the AMLCD driving methods described in the embodiments of the invention.

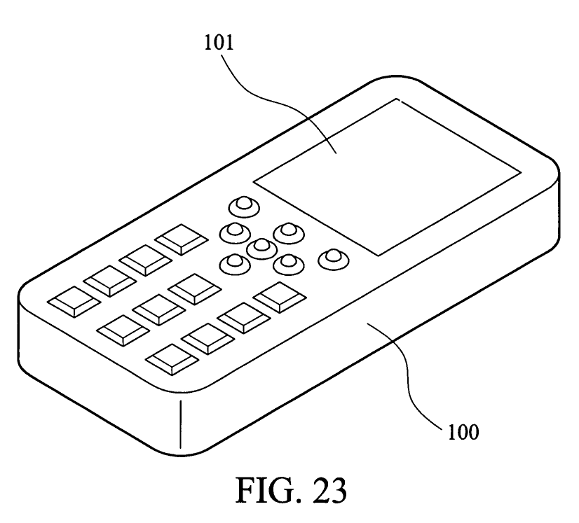

FIG. 23 shows a perspective view of a mobile phone installed with an active matrix liquid crystal display driven by the AMLCD driving methods described in the embodiments of the invention.

The AMLCD, driven by the AMLCD driving methods described in the embodiments of the invention, can be applied as the display 101 of the mobile phone 100. However, the AMLCD is not limited to mobile phone application, and it can be applied to a digital camera, personal data agent (PDA), notebook computer, desktop computer, television receiver, car-mounting display or portable DVD player.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for driving an active matrix liquid crystal display (AMLCD) which drives the AMLCD to perform partial display area displaying on a portion of a display area thereof, comprising:
using a common electrode voltage for line alternate-driving in a first write period of a partial display area, and for frame alternate-driving in at least a portion of a second write period outside of the partial display area; and
in a frame alternate-driving period of the second write period outside of the partial display area, controlling the common electrode voltage to adjust one of two voltage durations of the common electrode voltage which are respectively before and after the first write period of the partial display area and in which the common electrode voltage are of the same polarity, to make the two voltage durations have equal lengths.

2. The method as claimed in claim 1, wherein in the frame alternate-driving period of the second write period outside of the partial display area, the common electrode voltage is controlled such that a portion of one of the two voltage durations of the common electrode voltage is replaced by a middle voltage period, in which the common electrode voltage is set to a middle voltage of a positive common voltage and a negative common voltage, thereby shortening one of the two voltage durations and making the two voltage durations of the same polarity have equal lengths.

3. The method as claimed in claim 1, wherein in the frame alternate-driving period of the second write period outside of the partial display area, the common electrode voltage is controlled such that one of the two voltage durations of the common electrode voltage is extended, thereby making the two voltage durations of the same polarity have equal lengths.

4. The method as claimed in claim 2, wherein when the middle voltage period replacing one of the two voltage durations includes a write period of an Off area, a source electrode middle voltage is output by a source electrode driving circuit in a refresh frame time period to pixel electrodes corresponding to the middle voltage period of the Off area where the source electrode middle voltage is a middle source voltage of a positive write voltage and a negative write voltage from the source electrode driving circuit.

5. The method as claimed in claim 4, wherein when the middle voltage period replacing one of the two voltage durations includes a write period of dummy gates, and the source electrode middle voltage is output by the source electrode driving circuit during the refresh frame time period for the dummy gates corresponding to the middle voltage period of the Off area.

6. The method as claimed in claim 1, further comprising the step to set the line number of pixel electrodes for constructing the partial display area as an odd number.

7. The method as claimed in claim 6, further comprising the step of outputting an OFF-color voltage from a source electrode driving circuit to an additional pixel electrode which is used for setting the line number of pixel electrodes as the odd number.

8. The method as claimed in claim 7, further comprising the step of only scanning the pixel electrodes, excepting the additional pixel electrode, of the partial display area in a non-refresh frame period of the Off area.

9. The method as claimed in claims 1, further comprising the step of applying a middle source voltage of a positive write voltage and a negative voltage to source electrodes in a non-refresh frame time period of an Off area outside of the partial display area.

10. The method as claimed in claims 1, further comprising the steps of setting an output of a source electrode driving circuit as a high impedance in a non-refresh frame time period of an Off area outside of the partial display area.

11. The method as claimed in claims 1, further comprising the steps of applying a middle source voltage of a positive write voltage and a negative voltage to source electrodes and then setting an output of a source electrode driving circuit as a high impedance in a non-refresh frame time period of an Off area outside of the partial display area.

12. A method for driving an active matrix liquid crystal display (AMLCD) which drives the AMLCD to perform partial display area displaying on a portion of a display area thereof, comprising:
using a common electrode voltage for line alternate-driving in a first write period of a partial display area, and making the common electrode voltage become a middle voltage of a positive common voltage and a negative common voltage in a second write period outside of the partial display area; and
controlling the common electrode voltage such that two voltage durations of the common electrode voltage which are respectively before and after the first write period of the partial display area and have a specific voltage level of the same positive or negative polarity, are adjusted to have equal lengths of zero.

13. The method as claimed in claim 12 wherein when a middle voltage period, in which the common electrode voltage becomes the middle voltage, includes a write period of an Off area, a source electrode middle voltage is output by a source electrode driving circuit in a refresh frame time period to pixel electrodes corresponding to the middle voltage period of the Off area where the source electrode middle voltage is a middle source voltage of a positive write and negative voltages from the source electrode driving circuit.

14. The method as claimed in claim 13 wherein when the middle voltage period, in which the common electrode voltage becomes the middle voltage, includes a write period of dummy gates, and the source electrode middle voltage is output by the source electrode driving circuit during the refresh frame time period for the dummy gates corresponding to the middle voltage period.

15. The method as claimed in claim 12, further comprising the step to set the line number of pixel electrodes for constructing the partial display area as an odd number.

16. The method as claimed in claim 15, further comprising the step of outputting an OFF-color voltage from a source electrode driving circuit to an additional pixel electrode which is used for setting the line number of pixel electrodes as the odd number.

17. The method as claimed in claim 16, further comprising the step of only scanning the pixel electrodes of the partial display area and the additional pixel electrode in a non-refresh frame time period of the Off area.

18. The method as claimed in claim 12, further comprising the step of applying a middle source voltage between a positive write voltage and a negative voltage to source electrodes in a non-refresh frame time period of an Off area outside of the partial display area.

19. The method as claimed in claim 12, further comprising the steps of setting an output of a source electrode driving circuit as a high impedance in a non-refresh frame time period of an Off area outside of the partial display area.

20. The method as claimed in claim 12, further comprising the steps of applying a middle source voltage between a positive write voltage and a negative voltage to source electrodes and then setting an output of a source electrode driving circuit as a high impedance in a non-refresh frame time period of an Off area outside of the partial display area.

21. An electronic apparatus having an active matrix liquid crystal display driven by the method as claimed in claim 1.

22. The electronic apparatus as claimed in claim 21 wherein the electronic apparatus is a digital camera, personal data agent (PDA), notebook computer, desktop computer, television receiver, car-mounting display or portable DVD player.
